(19) United States
(12) Patent Application Publication
(10) Pub. No.: US 2009/0081469 A1
(43) Pub. Date: Mar. 26, 2009

(54) PRESSURE-SENSITIVE ADHESIVE COMPOSITION CONTAINING NEAR INFRARED RAY ABSORPTION AGENT

(75) Inventors: Shigeru Oka, Osaka (JP); Masahiko Saito, Osaka (JP); Akio Ito, Osaka (JP); Nobuhiro Kobayashi, Osaka (JP)

Correspondence Address: BUCHANAN, INGERSOLL & ROONEY PC, POST OFFICE BOX 1404, ALEXANDRIA, VA, 22313-1404, US

(73) Assignee: NIPPON SHOKUBAI CO., LTD., Osaka-shi (JP)

(21) Appl. No.: 11/913,218

(22) PCT Filed: May 9, 2006
(86) PCT No.: PCT/JP2006/309615

§ 371 Date: Oct. 31, 2007

(30) Foreign Application Priority Data
May 10, 2005 (JP) 2005-137546

(51) Int. Cl. B32B 17/10; C09J 9/00; C09J 7/02; B32B 27/06; B32B 27/36; C09J 133/06

(52) U.S. Cl. 428/441; 524/88; 428/483; 428/500

(57) ABSTRACT

The present invention provides a pressure-sensitive adhesive composition containing a near infrared ray absorption agent excellent in heat resistance and hygrothermal resistance while maintaining sufficient NIR shield characteristics and transparency. The problem can be solved with a pressure-sensitive adhesive composition, comprising: (I) at least one kind selected from phthalocyanine-based compound and naphthalocyanine-based compound having maximum absorption wavelength in a region from 800 to 920 nm, as near infrared ray absorption agents; (II) at least one kind selected from phthalocyanine-based compound and naphthalocyanine-based compound having maximum absorption wavelength in a region over 920 nm as near infrared ray absorption agents; and a pressure-sensitive adhesive resin having an acid value not higher than 25.

### TECHNICAL FIELD

The present invention relates to a pressure-sensitive adhesive composition containing a NIR absorption agent, and in particular, relates to a pressure-sensitive adhesive composition containing a near infrared ray (NIR) absorption agent excellent in heat resistance and hygrothermal resistance.

### BACKGROUND ART

PDP (Plasma Display Panel) applicable to a thin and large screen has recently been noticed. PDP has a problem of NIR light emission in plasma discharge, which induces false operation of appliances such as a home TV set, an air-conditioner and a video cassette recorder, and the like. To solve such a problem, there is an invention on a NIR shield film having high degree of NIR shielding and visible light transmission (JP-A-2001-133624). The NIR shield film disclosed in JP-A-2001-133624 is composed by lamination of a transparent resin film, a transparent NIR shield layer containing a NIR absorption agent, a transparent resin film, and a transparent color tone compensation layer containing a color material to compensate color tone of the transparent NIR shield layer. In this case, a diimmonium compound is used as a NIR absorption agent, in view of having most effective cutting ability of light having a wavelength of over 920 nm.

On the other hand, color tone is also important as well as NIR absorption characteristics, to be used as a panel of display and the like, and usually several kinds of dyes are required to be mixed to adjust color tone. However, among dyes having absorption characteristics in a NIR region, there are dyes that change the characteristics when mixed with other dyes, or change the NIR absorption ability caused by a chemical reaction and the like or dielectric interaction. In addition, because a panel production includes a step for melt extrusion or polymerization reaction at high temperature, use of a thermally or chemically stable NIR absorption material is necessary. To deal with these problems, for example, NIR absorption filters formed by any one of a casting method, a coating method from a solution of homogeneously mixed with a dye having NIR absorption ability and a polymer resin into a solvent, or a melt-extrusion method of an admixture of the dye and the polymer resin, or a polymerization method for polymerization or solidification of a mixture of a homogeneously mixed a dye having NIR absorption ability and a monomer, have been disclosed (JP-A-2002-82219). In the methods disclosed in the JP-A-2002-82219, each of the films is produced separately by a molding method in response to characteristics thereof and laminating theses films, to attain objective NIR absorption range, because, among dyes, there are dyes that change characteristics when mixed with other dyes, or have a chemical reaction and the like or dielectric interaction, or having poor heat stability. In this connection, as a NIR absorption agent, phthalocyanine-based dyes, diimmonium compounds, dithiol nickel complexes, polymethine-based dyes, and the like are exemplified.

Furthermore, such a NIR absorption film that was obtained by forming, on a transparent substrate, a resin layer with a thickness of 1 to 50 μm, containing one or more kinds of a NIR absorption dye (A dye) having maximum absorption wavelength at 800 to 1200 nm, and one or more kinds of a NIR absorption dye (B dye) having maximum absorption wavelength at 575 to 595 nm and a half-value width of not larger than 40 nm, has also been disclosed (JP-A-2002-187229). As the NIR absorption dye having maximum absorption wavelength at 800 to 1200 nm, a phthalocyanine-based dye is exemplified. In addition, as a dye having selective absorption of neon emission, namely the B dye having maximum absorption wavelength at 575 to 595 nm and a half-value width of not larger than 40 nm, a cyanine-based dye is exemplified.

In addition, a NIR absorption material using a transparent resin coating film containing a NIR absorption dye, and a dye selectively absorbs only a wavelength of 550 to 620 nm region has also been disclosed (US-2002/127395). It aims at removing this wavelength, because this wavelength is orange light making image unclear. In this connection, as the NIR absorption dye used in the publication, a dithiol-nickel complex and a diimmonium compound are included, and as the dye selectively absorbing only orange light (550 to 620 nm region), a cyanine-based dye is exemplified.

Excellent transmission in visible light region is also an important element as well as NIR shielding for a NIR shield filter for display.

### DISCLOSURE OF THE INVENTION

However, a diimmonium compound used in a NIR shield film disclosed in JP-A-2001-133624 has a problem of poor chemical stability in a solvent or a resin, resulting in color tone change or fading out, as well as poor heat stability, hygrothermal stability or light resistance, and therefore makes impossible to form a transparent NIR shield layer containing a NIR absorption agent, and a transparent resin film layer as the same layer, which in turn requires presence of an independent layer, and increases number of production steps accompanying with increase in number of laminated layers, and increases troublesome work.

In addition, an diimmonium compound used as a NIR absorption agent, which is used in a NIR absorption filter described in JP-A-2002-82219 has also the above problem, and in addition, a dithiol-nickel complex has insufficient solubility in a solvent and may be inferior in compatibility with a resin in some cases, which poses a problem that transmission in visible light region is lowered and clear image may not be obtained in some cases. In addition, in JP-A-2002-82219, as a resin to be mixed with a NIR absorption resin, an aromatic diol compound or dicarboxylic acid is used, however, when such a hydroxyl group or a carboxyl group is present in a resin, it reacts with a NIR absorption agent and may lower NIR absorption in some cases.

In addition, as described in JP-A-2002-187229 and US-2002/127395, when multiple NIR absorption agents are used in combination, they chemically react by mixing them, or characteristics of each NIR absorption agent changes, which may result in insufficient fulfillment of NIR shield characteristics, and insufficient suppression effect of false operation of a remote controller and the like.

Therefore, the present invention is made under these circumstances, and it is an object of the present invention to provide a pressure-sensitive adhesive composition containing a NIR absorption agent excellent in heat resistance and hygrothermal resistance while maintaining sufficient NIR shield characteristics and transparency.

It is other object of the present invention to provide a pressure-sensitive adhesive composition, which enables to maintain NIR shield characteristics and transparency of the resultant an adhesive layer, even when the pressure-sensitive adhesive layer is formed by mixing a NIR absorption agent into a pressure-sensitive adhesive resin.

In JP-A-2004-309655, phthalocyanine having an maximum absorption wavelength of at least 800 to 920 nm, and phthalocyanine as a compound having an maximum absorption wavelength in a region over 920 nm, have excellent chemical stability in a solvent or a resin, which is considered to little bring about a problem such as change in color tone or color fading, when used by the addition into a high Tg binder or adhesives, compared with using a conventionally used diimmonium dye.

Under these circumstances, the present inventors has extensively studied to attain the object by noticing on these phthalocyanine compounds and found that phthalocyanine-based compound and naphthalocyanine-based compound having maximum absorption wavelength in a region over 920 nm, when mixed in a pressure-sensitive adhesive resin having acid value not higher than specified value, improves stability thereof. It has been found therefore that the resultant pressure-sensitive adhesive composition by dispersing the phthalocyanine-based compound and naphthalocyanine-based compound having maximum absorption wavelength in a region from 800 to 920 nm, and the phthalocyanine-based compound and naphthalocyanine-based compound having maximum absorption wavelength in a region over 920 nm into such a pressure-sensitive adhesive resin has high stability, enables to effectively cut a light of a NIR wavelength of 800 to 1200 nm derived from xenon emission, and enables to effectively suppress false operation of appliances over a long period. It has been found that such a pressure-sensitive adhesive composition can suitably be used to produce an optical filter or plasma display (in particular, a front panel of plasma display or a NIR absorption filter for plasma display). Based on the knowledge, the present invention has been completed.

Namely, an object of the present invention can be attained by a pressure-sensitive adhesive composition containing (I) at least one kind selected from phthalocyanine-based compound and naphthalocyanine-based compound having maximum absorption wavelength in a region from 800 to 920 nm, as near infrared ray (NIR) absorption agents; (II) at least one kind selected from phthalocyanine-based compound and naphthalocyanine-based compound having maximum absorption wavelength in a region over 920 nm as near infrared ray (NIR) absorption agents; and a pressure-sensitive adhesive resin having an acid value not higher than 25.

A pressure-sensitive adhesive composition of the present invention containing a NIR absorption agent is characterized by being composed of (I) having maximum absorption wavelength in a region from 800 to 920 nm, and (II) having maximum absorption wavelength in a region over 920 nm, as NIR absorption agents, along with a pressure-sensitive resin having an acid value not higher than 25. According to the present invention, because of using a pressure-sensitive adhesive resin having suppressed acid value thereof to not higher than specified value, stability of (II) can be improved. Therefore, the resultant pressure-sensitive adhesive composition by dispersing (I) and (II) in such a pressure-sensitive resin has advantages of having high stability and little change in color tone or color fading. In addition to these advantages, the resultant pressure-sensitive adhesive composition by dispersing phthalocyanines (I) and (II) of the present invention in such a pressure-sensitive adhesive resin enables to effectively cut a NIR wavelength of 800 to 1200 nm derived from xenon emission, and enables to effectively suppress false operation of appliances over a long period. Therefore, an optical filter or plasma display (in particular, a front panel of plasma display or a NIR absorption filter for plasma display) produced by using a pressure-sensitive adhesive composition of the present invention has high transparency in visible range, improved display appearance or excellent stability, and therefore enables to suppress false operation of a remote controller around plasma display and also change in display appearance.

Furthermore, because a pressure-sensitive adhesive layer and a NIR shield layer can be produced as one layer, a step for producing a front panel of plasma display or a NIR absorption filter for plasma display enables to be simplified.

Other objects, features and advantages of the present invention will be clarified by referring to preferable embodiments exemplified in the following explanation.

### DETAILED DESCRIPTION OF THE EMBODIMENT

A first embodiment of the present invention relates to a pressure-sensitive adhesive composition containing: (I) at least one kind selected from phthalocyanine-based compound and naphthalocyanine-based compound having maximum absorption wavelength in a region from 800 to 920 nm, as near infrared ray absorption agents; (II) at least one kind selected from phthalocyanine-based compound and naphthalocyanine-based compound having maximum absorption wavelength in a region over 920 nm as near infrared ray absorption agents; and a pressure-sensitive adhesive resin having an acid value not higher than 25. Conventionally, there has been reported on mixing a phthalocyanine-based compound and a polymer resin, however, there has not been well-known about detailed study on a resin, therefore, formation of a pressure-sensitive adhesive layer by mixing a polymer resin, in particular, a resin for pressure-sensitive adhesive, and a phthalocyanine-based compound often resulted in lowered stability, which forced the formation of two independent layers of a pressure-sensitive adhesive layer and a NIR shield layer. It is an object of the present invention to provide a single layer of a pressure-sensitive adhesive layer and a NIR shield layer, and it has been clarified that as a pressure-sensitive adhesive resin not to lower various properties such as NIR shield characteristics, heat stability (heat resistance), hygrothermal resistance or light resistance of the phthalocyanine, a pressure-sensitive adhesive resin having an acid value not higher than 25 can suitably be used. Namely, it has been clarified that stability of (II) can be improved in a pressure-sensitive adhesive resin having an acid value not higher than 25, and a single layer type optical filter or plasma display using this as a pressure-sensitive adhesive composition has little change in color tone nor color fading. It has also been found that combined use of (I) and (II) enables to effectively cut light of a NIR wavelength of 800 to 1200 nm derived from xenon emission, and enables to effectively suppress false operation of appliances over a long period. Therefore, a pressure-sensitive adhesive composition composed of (I) and (II), along with a pressure-sensitive adhesive resin having an acid value of not higher than 25 is significantly useful in forming a single layer having both functions of a pressure-sensitive adhesive layer and a NIR shield layer, and therefore, it can suitably be used to produce an optical filter or plasma display (in particular, a front panel of plasma display or a NIR absorption filter for plasma display).

The present invention is explained in more detail below.

### (1) Phthalocyanine-Based Compound and Naphthalocyanine-Based Compound

In the present invention, as a NIR absorption agent, (I) at least one kind selected from phthalocyanine-based compound and naphthalocyanine-based compound having maximum absorption wavelength in a region from 800 to 920 nm, and (II) at least one kind selected from phthalocyanine-based compound and naphthalocyanine-based compound having maximum absorption wavelength in a region over 920 nm are used. As (I) and (II), any compound can be used as long as having maximum absorption wavelength in a range of 800 to 920 nm, and over 920 nm.

As a phthalocyanine-based compound used as (I) and (II), compounds represented by the following formula (1) are preferable:

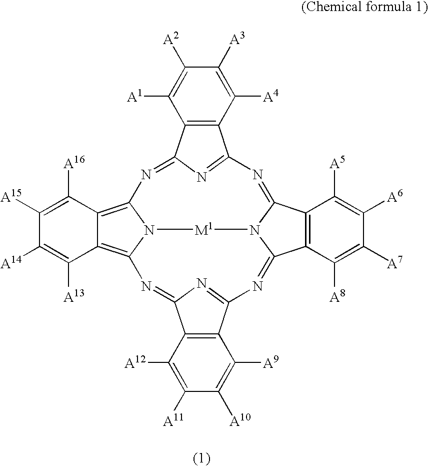

A¹ to A⁶ in the formula (1) represent functional groups, and each independently represent a hydrogen atom, a halogen atom, a hydroxyl group, a hydroxysulfonyl group, a carboxyl group, a thiol group, an alkyl group which may be substituted, and having carbon atoms of 1 to 20, an alkoxy group which may be substituted, and having carbon atoms of 1 to 20, an aryl group which may be substituted, and having carbon atoms of 6 to 20, an aryloxy group which may be substituted, and having carbon atoms of 6 to 20, an aralkyl group which may be substituted, and having carbon atoms of 7 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, an alkylsulfonyl group which may be substituted, and having carbon atoms of 1 to 20, an arylsulfonyl group which may be substituted, and having carbon atoms of 6 to 20, an aralkylsulfonyl group which may be substituted, and having carbon atoms of 7 to 20, an acyl group which may be substituted, and having carbon atoms of 1 to 20 (an acyl group indicates one described on page 17 in Comprehensive Dictionary of Science Technical Terms, third edition, published from Daily Industrial Newspaper Co., Ltd.), an alkoxycarbonyl group which may be substituted, and having carbon atoms of 2 to 20, an aryloxycarbonyl group which may be substituted, and having carbon atoms of 7 to 20, an aralkyloxycarbonyl group which may be substituted, and having carbon atoms of 8 to 20, an alkylcarbonyloxy group which may be substituted, and having carbon atoms of 2 to 20, an arylcarbonyloxy group which may be substituted, and having carbon atoms of 7 to 20, an aralkylcarbonyloxy group which may be substituted, and having carbon atoms of 8 to 20, a heterocyclic group which may be substituted, and having carbon atoms of 2 to 20, an amino group which may be substituted, an aminosulfonyl group which may be substituted, and an aminocarbonyl group which may be substituted. Functional groups, A¹ to A¹⁶ may be any of the same kind or different kind, and also in the case of the same kinds, they may be the same or different, and functional groups themselves may be bonded via a linking group. M¹ represents 2 hydrogen atoms, a bivalent metal atom, a trivalent or tetravalent substituted metal atom or an oxy metal.

(In the Case of Functional Groups Other than Amino Group, Aminosulfonyl Group and Aminocarbonyl Group)

As a halogen atom for functional groups A¹ to A¹⁶ in the formula (1), fluorine atom, chlorine atom, bromine atom, and iodine atom are included. As an alkyl group which may be substituted, and having carbon atoms of 1 to 20, straight, branched, or cyclic alkyl groups such as methyl group, ethyl group, n-propyl group, iso-propyl group, n-butyl group, iso-butyl group, sec-butyl group, t-butyl group, n-pentyl group, n-hexyl group, cyclohexyl group, n-heptyl group, n-octyl group, and 2-ethylhexyl group are included, however, it is not limited thereto. As an alkoxy group which may be substituted, and having carbon atoms of 1 to 20, straight, branched, or cyclic alkoxy groups such as methoxy group, ethoxy group, n-propyloxy group, iso-propyloxy group, n-butyloxy group, iso-butyloxy group, sec-butyloxy group, t-butyloxy group, n-pentyloxy group, n-hexyloxy group, cyclohexyloxy group, n-heptyloxy group, n-octyloxy group, and 2-ethylhexyloxy group are included, however, it is not limited thereto. As an aryl group which may be substituted, and having carbon atoms of 6 to 20, phenyl group, naphthyl group, and the like are included, however, it is not limited thereto. As an aryloxy group which may be substituted, and having carbon atoms of 6 to 20, phenoxy group, naphthoxy group, and the like are included, however, it is not limited thereto. As an aralkyl group which may be substituted, and having carbon atoms of 7 to 20, benzyl group, phenethyl group, diphenylmethyl group, and the like are included, however, it is not limited thereto. As an aralkyloxy group which may be substituted, and having carbon atoms of 7 to 20, benzyloxy group, phenethyloxy group, diphenylmethyloxy group, and the like are included, however, it is not limited thereto. As an alkylthio group which may be substituted, and having carbon atoms of 1 to 20, straight, branched, or cyclic alkylthio groups such as methylthio group, ethylthio group, n-propylthio group, iso-propylthio group, n-butylthio group, iso-butylthio group, sec-butylthio group, t-butylthio group, n-pentylthio group, n-hexylthio group, cyclohexylthio group, n-heptylthio group, n-octylthio group, and 2-ethylhexylthio group are included, however, it is not limited thereto. As an arylthio group which may be substituted, and having carbon atoms of 6 to 20, phenylthio group, naphthylthio group, and the like are included, however, it is not limited thereto. As an aralkylthio group which may be substituted, and having carbon atoms of 7 to 20, benzylthio group, phenethylthio group, diphenylmethylthio group, and the like are included, however, it is not limited thereto. As an alkylsulfonyl group which may be substituted, and having carbon atoms of 1 to 20, straight, branched, or cyclic alkylsulfonyl groups such as methylsulfonyl group, ethylsulfonyl group, n-propylsulfonyl group, iso-propylsulfonyl group, n-butylsulfonyl group, iso-butylsulfonyl group, sec-butylsulfonyl group, t-butylsulfonyl group, n-pentylsulfonyl group, n-hexylsulfonyl group, cyclohexylsulfonyl group, n-heptylsulfonyl group, n-octylsulfonyl group, and 2-ethylhexylsulfonyl group are included, however, it is not limited thereto. As an arylsulfonyl group which may be substituted, and having carbon atoms of 6 to 20, phenylsulfonyl group, naphthylsulfonyl group, and the like are included, however, it is not limited thereto. As an aralkylsulfonyl group which may be substituted, and having carbon atoms of 7 to 20, benzylsulfonyl group, phenethylsulfonyl group, diphenylmethylsulfonyl group, and the like are included, however, it is not limited thereto. As an acyl group which may be substituted, and having carbon atoms of 1 to 20, straight, branched, or cyclic alkylcarbonyl groups such as methylcarbonyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, n-octylcarbonyl group, and 2-ethylhexylcarbonyl group are included, however, it is not limited thereto. As an arylcarbonyl group which may be substituted, and having carbon atoms of 7 to 20, arylcarbonyl groups such as benzylcarbonyl group, and phenylcarbonyl group are included, however, it is not limited thereto. As an aralkylcarbonyl group which may be substituted, and having carbon atoms of 7 to 20, aralkylcarbonyl group such as benzoyl group is included, however, it is not limited thereto. As an alkoxycarbonyl group which may be substituted, and having carbon atoms of 2 to 20, methoxycarbonyl group, ethoxycarbonyl group, n-propyloxycarbonyl group, iso-propyloxycarbonyl group, n-butyloxycarbonyl group, iso-butyloxycarbonyl group, sec-butyloxycarbonyl group, t-butyloxycarbonyl group, n-pentyloxycarbonyl group, n-hexyloxycarbonyl group, cyclohexyloxycarbonyl group, n-heptyloxycarbonyl group, n-octyloxycarbonyl group, 2-ethylhexyloxycarbonyl group, and the like are included, however, it is not limited thereto. As an aryloxycarbonyl group which may be substituted, and having carbon atoms of 7 to 20, phenoxycarbonyl group, naphthoxycarbonyl group, and the like are included, however, it is not limited thereto. As an aralkyloxycarbonyl group which may be substituted, and having carbon atoms of 8 to 20, benzyloxycarbonyl group, phenethyloxycarbonyl group, diphenylmethyloxycarbonyl group, and the like are included, however, it is not limited thereto. As an alkylcarbonyloxy group which may be substituted, and having carbon atoms of 2 to 20, acetyloxy group, ethylcarbonyloxy group, n-propylcarbonyloxy group, iso-propylcarbonyloxy group, n-butylcarbonyloxy group, iso-butylcarbonyloxy group, sec-butylcarbonyloxy group, t-butylcarbonyloxy group, n-pentylcarbonyloxy group, n-hexylcarbonyloxy group, cyclohexylcarbonyloxy group, n-heptylcarbonyloxy group, 3-heptylcarbonyloxy group, n-octylcarbonyloxy group, and the like are included, however, it is not limited thereto. As an arylcarbonyloxy group which may be substituted, and having carbon atoms of 7 to 20, benzoyloxy group, and the like are included, however, it is not limited thereto. As an aralkylcarbonyloxy group which may be substituted, and having carbon atoms of 8 to 20, benzylcarbonyloxy group, and the like are included, however, it is not limited thereto. As a heterocyclic group which may be substituted, and having carbon atoms of 2 to 20, pyrrole group, imidazole group, piperidine group, morpholine group, and the like are included, however, it is not limited thereto.

As substituents present, if necessary, to functional groups A¹ to A¹⁶ in formula (1), namely, alkyl group, alkoxy group, aryl group, aryloxy group, aralkyl group, aralkyloxy group, alkylthio group, arylthio group, aralkylthio group, alkylsulfonyl group, arylsulfonyl group, aralkylsulfonyl group, acyl group, alkoxycarbonyl group, aryloxycarbonyl group, aralkyloxycarbonyl group, alkylcarbonyloxy group, arylcarbonyloxy group, aralkylcarbonyloxy group, and heterocyclic group, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like are included, however, they are not limited thereto. These substituents may be present in plural, and when they are present in plural, they may be any of the same kind or different kind, and also in the case of the same kinds, they may be the same or different. Substituents themselves may be bonded via a linking group.

### (In the Case of Amino Group, Aminosulfonyl Group and Aminocarbonyl Group)

As substituents to functional groups A¹ to A¹⁶ in the formula (1), namely, an amino group which may be substituted, an aminosulfonyl group which may be substituted, and an aminocarbonyl group which may be substituted, hydrogen atom, straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, and naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; aralkylcarbonyl groups such as benzylcarbonyl group, and the like, are included, however, they are not limited thereto, and these substituents may further be substituted with a substituent. These substituents may not be present, or may be present one or two, and when two substituents are present, they may be any of the same kind or different kind each other, and also in the case of the same kinds, they may be any of the same or different. In addition, when two substituents are present, they may be bonded via a linking group.

As substituents which may be further present to alkyl group, aryl group, aralkyl group, alkylcarbonyl group, arylcarbonyl group, and aralkylcarbonyl group, that is substituents to an amino group which may be substituted, an aminosulfonyl group which may be substituted, and an aminocarbonyl group which may be substituted, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, may be any of the same kind or different kind, and also in the case of the same kinds, they may be the same or different. Substituents themselves may be bonded via a linking group.

In addition, as examples of bivalent metals in Ml of formula (1), Cu(II), Co(II), Zn(II), Fe(II), Ni(II), Ru(II), Rh(II), Pd(II), Pt(II), Mn(II), Mg(II), Ti(II), Be(II), Ca(II), Ba(II), Cd(II), Hg(II), Pb(II), Sn(II), and the like are included, however, they are not limited thereto. As examples of trivalent substituted metals, Al—F, Al—Cl, Al—Br, Al—I, Fe—Cl, Ga—F, Ga—Cl, Ga—I, Ga—Br, In—F, In—Cl, In—Br, In—I, Tl—F, Tl—Cl, Tl—Br, Tl—I, Al—C₆H₅, Al—C₆H₄(CH₃), In—C₆H₅, In—C₆H₄ (CH₃), In—C₆H₅, Mn (OH), Mn (OC₆H₅), Mn[OSi(CH₃)₃], Ru—Cl, and the like are included, however, they are not limited thereto. As examples of tetravalent substituted metals, CrCl₂, SiF₂, SiCl₂, SiBr₂, SiI₂, ZrCl₂, GeF₂, GeCl₂, GeBr₂, GeI₂, SnF₂, SnCl₂, SnBr₂, TiF₂, TiCl₂, TiBr₂, Ge(OH)₂, Mn(OH)₂, Si(OH)₂, Sn(OH)₂, Zr(OH)₂, Cr(R¹)₂, Ge (R¹)₂, Si (R¹)₂, Sn(R¹)₂, Ti(R¹)₂, (R¹ represents alkyl group, phenyl group, naphthyl group, and derivatives thereof), Cr(OR²)₂, Ge(OR²)₂, Si(OR²)₂, Sn(OR²)₂, Ti(OR²)₂, (R² represents alkyl group, phenyl group, naphthyl group, trialkylsilyl group, dialkylalkoxysilyl group, and derivatives thereof), Sn(SR³)₂, Ge(SR³)₂, (R³ represents alkyl group, phenyl group, naphthyl group, and derivatives thereof), and the like are included, however, they are not limited thereto. As examples of oxymetals, VO, MnO, TiO, and the like are included, however, they are not limited thereto.

As a naphthalocyanine-based compound used as (I) and (II), compounds represented by the following formula (2) are preferable:

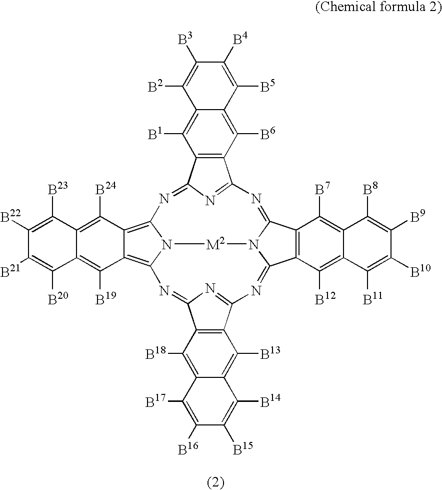

In the formula (2), B¹ to B²⁴ represent functional groups, and each independently represent a hydrogen atom, a halogen atom, a hydroxyl group, a hydroxysulfonyl group, a carboxyl group, a thiol group, an alkyl group which may be substituted, and having carbon atoms of 1 to 20, an alkoxy group which may be substituted, and having carbon atoms of 1 to 20, an aryl group which may be substituted, and having carbon atoms of 6 to 20, an aryloxy group which may be substituted, and having carbon atoms of 6 to 20, an aralkyl group which may be substituted, and having carbon atoms of 7 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, an alkylsulfonyl group which may be substituted, and having carbon atoms of 1 to 20, an arylsulfonyl group which may be substituted, and having carbon atoms of 6 to 20, an aralkylsulfonyl group which may be substituted, and having carbon atoms of 7 to 20, an acyl group which may be substituted, and having carbon atoms of 1 to 20 (an acyl group indicates one described on page 17 in Comprehensive Dictionary of Science Technical Terms, third edition, published from daily Industrial Newspaper Co., Ltd.), an alkoxycarbonyl group which may be substituted, and having carbon atoms of 2 to 20, an aryloxycarbonyl group which may be substituted, and having carbon atoms of 7 to 20, an aralkyloxycarbonyl group which may be substituted, and having carbon atoms of 8 to 20, an alkylcarbonyloxy group which may be substituted, and having carbon atoms of 2 to 20, an arylcarbonyloxy group which may be substituted, and having carbon atoms of 7 to 20, an aralkylcarbonyloxy group which may be substituted, and having carbon atoms of 8 to 20, a heterocyclic group which may be substituted, and having carbon atoms of 2 to 20, an amino group which may be substituted, an aminosulfonyl group which may be substituted, and an aminocarbonyl group which may be substituted. Functional groups B¹ to B²⁴ may be any of the same kind or different kind, and also in the case of the same kinds, they may be the same or different, and functional groups themselves may be bonded via a linking group. M² represents 2 hydrogen atoms, a bivalent metal atom, a trivalent or tetravalent substituted metal atom or an oxy metal.

(In the Case of Functional Groups Other than Amino Group, Aminosulfonyl Group and Aminocarbonyl Group)

In the formula (2), as a halogen atom for functional groups B¹ to B²⁴, fluorine atom, chlorine atom, bromine atom, and iodine atom are included. As an alkyl group which may be substituted, and having carbon atoms of 1 to 20, straight, branched, or cyclic alkyl groups such as methyl group, ethyl group, n-propyl group, iso-propyl group, n-butyl group, iso-butyl group, sec-butyl group, t-butyl group, n-pentyl group, n-hexyl group, cyclohexyl group, n-heptyl group, n-octyl group, and 2-ethylhexyl group are included, however, it is not limited thereto. As an alkoxy group which may be substituted, and having carbon atoms of 1 to 20, straight, branched, or cyclic alkoxy groups such as methoxy group, ethoxy group, n-propyloxy group, iso-propyloxy group, n-butyloxy group, iso-butyloxy group, sec-butyloxy group, t-butyloxy group, n-pentyloxy group, n-hexyloxy group, cyclohexyloxy group, n-heptyloxy group, n-octyloxy group, and 2-ethylhexyloxy group are included, however, it is not limited thereto. As an aryl group which may be substituted, and having carbon atoms of 6 to 20, phenyl group, naphthyl group, and the like are included, however, it is not limited thereto. As an aryloxy group which may be substituted, and having carbon atoms of 6 to 20, phenoxy group, naphthoxy group, and the like are included, however, it is not limited thereto. As an aralkyl group which may be substituted, and having carbon atoms of 7 to 20, benzyl group, phenethyl group, diphenylmethyl group, and the like are included, however, it is not limited thereto. As an aralkyloxy group which may be substituted, and having carbon atoms of 7 to 20, benzyloxy group, phenethyloxy group, diphenylmethyloxy group, and the like are included, however, it is not limited thereto. As an alkylthio group which may be substituted, and having carbon atoms of 1 to 20, straight, branched, or cyclic alkylthio groups such as methylthio group, ethylthio group, n-propylthio group, iso-propylthio group, n-butylthio group, iso-butylthio group, sec-butylthio group, t-butylthio group, n-pentylthio group, n-hexylthio group, cyclohexylthio group, n-heptylthio group, n-octylthio group, and 2-ethylhexylthio group are included, however, it is not limited thereto. As an arylthio group which may be substituted, and having carbon atoms of 6 to 20, phenylthio group, naphthylthio group, and the like are included, however, it is not limited thereto. As an aralkylthio group which may be substituted, and having carbon atoms of 7 to 20, benzylthio group, phenethylthio group, diphenylmethylthio group, and the like are included, however, it is not limited thereto. As an alkylsulfonyl group which may be substituted, and having carbon atoms of 1 to 20, straight, branched, or cyclic alkylsulfonyl groups such as methylsulfonyl group, ethylsulfonyl group, n-propylsulfonyl group, iso-propylsulfonyl group, n-butylsulfonyl group, iso-butylsulfonyl group, sec-butylsulfonyl group, t-butylsulfonyl group, n-pentylsulfonyl group, n-hexylsulfonyl group, cyclohexylsulfonyl group, n-heptylsulfonyl group, n-octylsulfonyl group, and 2-ethylhexylsulfonyl group are included, however, it is not limited thereto. As an arylsulfonyl group which may be substituted, and having carbon atoms of 6 to 20, phenylsulfonyl group, naphthylsulfonyl group, and the like are included, however, it is not limited thereto. As an aralkylsulfonyl group which may be substituted, and having carbon atoms of 7 to 20, benzylsulfonyl group, phenethylsulfonyl group, diphenylmethylsulfonyl group, and the like are included, however, it is not limited thereto. As an acyl group which may be substituted, and having carbon atoms of 1 to 20, straight, branched, or cyclic alkylcarbonyl groups such as methylcarbonyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, n-octylcarbonyl group, and 2-ethylhexylcarbonyl group are included, however, it is not limited thereto. As an arylcarbonyl group which may be substituted, and having carbon atoms of 7 to 20, arylcarbonyl groups such as benzylcarbonyl group, and phenylcarbonyl group are included, however, it is not limited thereto. As an aralkylcarbonyl group which may be substituted, and having carbon atoms of 7 to 20, aralkylcarbonyl group such as benzoyl group is included, however, it is not limited thereto. As an alkoxycarbonyl group which may be substituted, and having carbon atoms of 2 to 20, methoxycarbonyl group, ethoxycarbonyl group, n-propyloxycarbonyl group, iso-propyloxycarbonyl group, n-butyloxycarbonyl group, iso-butyloxycarbonyl group, sec-butyloxycarbonyl group, t-butyloxycarbonyl group, n-pentyloxycarbonyl group, n-hexyloxycarbonyl group, cyclohexyloxycarbonyl group, n-heptyloxycarbonyl group, n-octyloxycarbonyl group, 2-ethylhexyloxycarbonyl group, and the like are included, however, it is not limited thereto. As an aryloxycarbonyl group which may be substituted, and having carbon atoms of 7 to 20, phenoxycarbonyl group, naphthoxycarbonyl group, and the like are included, however, it is not limited thereto. As an aralkyloxycarbonyl group which may be substituted, and having carbon atoms of 8 to 20, benzyloxycarbonyl group, phenethyloxycarbonyl group, diphenylmethyloxycarbonyl group, and the like are included, however, it is not limited thereto. As an alkylcarbonyloxy group which may be substituted, and having carbon atoms of 2 to 20, acetyloxy group, ethylcarbonyloxy group, n-propylcarbonyloxy group, iso-propylcarbonyloxy group, n-butylcarbonyloxy group, iso-butylcarbonyloxy group, sec-butylcarbonyloxy group, t-butylcarbonyloxy group, n-pentylcarbonyloxy group, n-hexylcarbonyloxy group, cyclohexylcarbonyloxy group, n-heptylcarbonyloxy group, 3-heptylcarbonyloxy group, n-octylcarbonyloxy group, and the like are included, however, it is not limited thereto. As an arylcarbonyloxy group which may be substituted, and having carbon atoms of 7 to 20, benzoyloxy group, and the like are included, however, it is not limited thereto. As an aralkylcarbonyloxy group which may be substituted, and having carbon atoms of 8 to 20, benzylcarbonyloxy group, and the like are included, however, it is not limited thereto. As a heterocyclic group which may be substituted, and having carbon atoms of 2 to 20, pyrrole group, imidazole group, piperidine group, morpholine group, and the like are included, however, it is not limited thereto.

As substituents present, if necessary, to functional groups B¹ to B²⁴ in formula (2), namely, alkyl group, alkoxy group, aryl group, aryloxy group, aralkyl group, aralkyloxy group, alkylthio group, arylthio group, aralkylthio group, alkylsulfonyl group, arylsulfonyl group, aralkylsulfonyl group, acyl group, alkoxycarbonyl group, aryloxycarbonyl group, aralkyloxycarbonyl group, alkylcarbonyloxy group, arylcarbonyloxy group, aralkylcarbonyloxy group, and hetero cyclic group, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like, are included, however, they are not limited thereto. These substituents may be present in plural, and when they are present in plural, may be any of the same kind or different kind, and also in the case of the same kinds, they may be the same or different. Substituents themselves may be bonded via a linking group.

### (In the Case of Amino Group, Aminosulfonyl Group and Aminocarbonyl Group)

As substituents to an amino group which may be substituted, an aminosulfonyl group which may be substituted, and an aminocarbonyl group which may be substituted, as functional groups B¹ to B²⁴ in the formula (2), hydrogen atom; straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, and naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; aralkylcarbonyl groups such as benzylcarbonyl group; and the like, are included, however, they are not limited thereto, and these substituents may further be substituted with a substituent. These substituents may not be present, or may be present one or two, and when two substituents are present, they may be any of the same kind or different kind, and also in the case of the same kinds, they may be any of the same or different.

In addition, when two substituents are present, they may be bonded via a linking group.

As substituents which may be further present to alkyl group, aryl group, aralkyl group, alkylcarbonyl group, arylcarbonyl group, and aralkylcarbonyl group, which are substituents to the amino group which may be substituted, the aminosulfonyl group which may be substituted, and the aminocarbonyl group which may be substituted, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, may be any of the same kind or different kind, and also in the case of the same kinds, they may be the same or different. Substituents themselves may be bonded via a linking group.

In addition, as examples of bivalent metals in M² of formula (2), Cu(II), Co(II), Zn(II), Fe(II), Ni(II), Ru(II), Rh(II), Pd(II), Pt(II), Mn(II), Mg(II), Ti(II), Be(II), Ca(II), Ba(II), Cd(II), Hg(II), Pb(II), Sn(II), and the like are included, however, they are not limited thereto. As examples of trivalent substitution metals, Al—F, Al—Cl, Al—Br, Al—I, Fe—Cl, Ga—F, Ga—Cl, Ga—I, Ga—Br, In—F, In—Cl, In—Br, In—I, Ti—F, Tl—Cl, Tl—Br, Tl—I, Al—C₆H₅, Al—C₆H₄ (CH₃), In—C₆H₅, In—C₆H₄(CH₃), In—C₆H₅, Mn(OH), Mn(OC₆H₅), Mn[OSi(CH₃)₃], Ru—Cl, and the like are included, however, they are not limited thereto. As examples of tetravalent substituted metals, CrCl₂, SiF₂, SiCl₂, SiBr₂, SiI₂, ZrCl₂, GeF₂, GeCl₂, GeBr₂, GeI₂, SnF₂, SnCl₂, SnBr₂, TiF₂, TiCl₂, TiBr₂, Ge(OH)₂, Mn(OH)₂, Si(OH)₂, Sn(OH)₂, Zr(OH)₂, Cr(R¹)₂, Ge(R¹)₂, Si (R¹)₂, Sn(R¹)₂, Ti(R¹)₂, (R¹ represents alkyl group, phenyl group, naphthyl group, and derivatives thereof), Cr(OR²)₂, Ge(OR²)₂, Si (OR²)₂, Sn(OR²)₂, Ti(OR²)₂, (R² represents alkyl group, phenyl group, naphthyl group, trialkylsilyl group, dialkylalkoxysilyl group, and derivatives thereof), Sn(SR³)₂, Ge(SR³)₂, (R³ represents alkyl group, phenyl group, naphthyl group, and derivatives thereof), and the like are included, however, they are not limited thereto. As examples of oxymetals, VO, MnO, TiO, and the like are included, however, they are not limited thereto.

Further, (I) preferably used in the present invention is a phthalocyanine-based compound represented by the following formula (3):

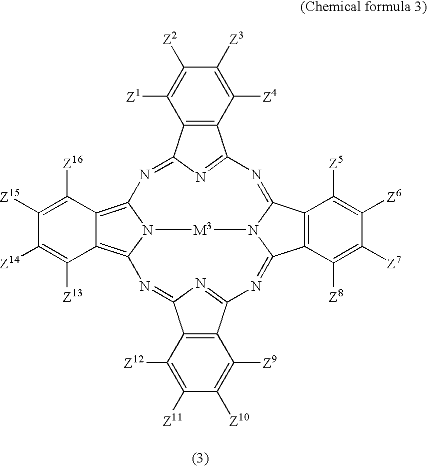

In the formula (3), Z¹ to Z¹⁶ represent functional groups, and each independently represent a halogen atom, an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, a heterocyclic group which may be substituted, and having carbon atoms of 2 to 20, an amino group which may be substituted. Functional groups Z¹ to Z¹⁶ may be any of the same kind or different kind, and also in the case of the same kinds, they may be the same or different, and functional groups themselves may be bonded via a linking group. More preferably, at least 4 groups among functional groups Z¹ to Z¹⁶ in formula (3), each independently, are those such as an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, and an aralkylthio group which may be substituted, and having carbon atoms of 7 to 20, and at least 1 group is a heterocyclic group which may be substituted, and having carbon atoms of 2 to 20, an amino group which may be substituted. In addition, in the case when these substituents are the same kinds, they may be the same or different, and functional groups themselves may be bonded via a linking group.

M³ represents 2 hydrogen atoms, a bivalent metal atom, a trivalent or tetravalent substituted metal atom or an oxy metal. In the case when M³ represents a bivalent metal atom, a trivalent or tetravalent substituted metal atom or an oxy metal, examples described in the formula (1) are included.

As substituents present, if necessary, to alkoxy group, aryloxy group, aralkyloxy group, alkylthio group, arylthio group, aralkylthio group, and hetero cyclic group in formula (3), for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like are included, however, they are not limited thereto. These substituents may be present in plural, and when they are present in plural, they may be any of the same kind or different kind, and also in the case of the same kinds, they may be the same or different. Substituents themselves may be bonded via a linking group.

As substituents to an amino group which may be substituted in formula (3), hydrogen atom; straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, and naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; aralkylcarbonyl groups such as benzylcarbonyl group; and the like, are included however, they are not limited thereto, and these substituents may further be substituted by a substituent. These substituents may not be present, or one or two may be present. When they are present in two, they may be any of the same kind or different kind each other, and also in the case of the same kinds, they may be the same or different. Substituents themselves may be bonded via a linking group.

As substituents present which may be further present to alkyl group, aryl group, aralkyl group, alkylcarbonyl group, arylcarbonyl group, aralkylcarbonyl group, which are substituents to the amino group which may be substituted, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, they may be any of the same kind or different kind, and also in the case of the same kinds, they may be the same or different. Substituents themselves may be bonded via a linking group.

Further, other (I) more preferably used in the present invention is a naphthalocyanine-based compound represented by the following formula (4):

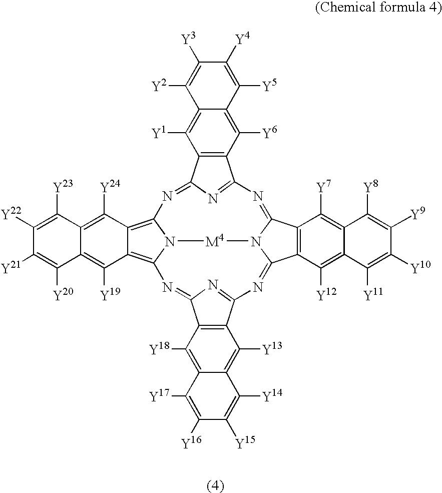

In the formula (4), Y¹ to Y²⁴ represent functional groups, and each independently represent a halogen atom, an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, a heterocyclic group which may be substituted, and having carbon atoms of 2 to 20, and an amino group which may be substituted. Functional groups Y¹ to Y²⁴ may be any of the same kind or different kind, and also in the case of the same kinds, they may be the same or different, and functional groups themselves may be bonded via a linking group. M⁴ represents 2 hydrogen atoms, a bivalent metal atom, a trivalent or tetravalent substituted metal atom or an oxy metal. In the case when M⁴ represents a metal, examples described in the formula (2) are included.

As substituents present, if necessary, to alkoxy group, aryloxy group, aralkyloxy group, alkylthio group, arylthio group, aralkylthio group, and heterocyclic group in formula (4), for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like are included, however, they are not limited thereto. These substituents may be present in plural, and when they are present in plural, they may be any of the same kind or different kind, and also in the case of the same kinds, they may be the same or different. Substituents themselves may be bonded via a linking group.

As substituents to an amino group which may be substituted in formula (4), hydrogen atom; straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; aralkylcarbonyl groups such as benzylcarbonyl group; and the like are included, however, they are not limited thereto, and these substituents to an amino group may further be substituted by a substituent. These substituents to an amino group may not be present, or one or two may be present. When they are present in two, they may be any of the same kind or different kind each other, and also in the case of the same kinds, they may be the same or different. When two substituents are present, they themselves may be bonded via a linking group.

As substituents which may further be present to alkyl group, aryl group, aralkyl group, alkylcarbonyl group, arylcarbonyl group, aralkylcarbonyl group, and the like, which are substituents to the amino group which may be substituted, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, they may be any of the same kind or different kind, and also in the case of the same kinds, they may be the same or different. In addition, substituents themselves may be bonded via a linking group.

In the present invention, use in combination of one or more kinds having maximum absorption wavelength at not smaller than 800 nm below 850 nm and one or more kinds having maximum absorption wavelength at 850 to 920 nm, as the (I), has high visible light transmittance of the resultant NIR absorption filter and also enables to efficiently cut NIR light, and thus advantageous.

Among the (I), those having maximum absorption wavelength at not smaller than 800 nm below 920 nm are exemplified below. In the abbreviation of the following compounds, Ph represents a phenyl group, Pc represents a phthalocyanine nucleus, and just before Pc, M³ is shown, and just after Pc, 8 substituents at β-positions of a phthalocyanine nucleus (substitution positions of Z², Z³, Z⁶, Z⁷, Z¹⁰, Z¹¹, Z¹⁴ and Z¹⁵) are shown, and after the substituents at the β-positions, 8 substituents at α-positions of a phthalocyanine nucleus (substitution positions of Z¹, Z⁴, Z⁵, Z⁸, Z⁹, Z¹², Z¹³ and Z¹⁶) are shown. Those having maximum absorption wavelength at not smaller than 800 nm below 850 nm include, CuPc(2,5-Cl₂PhO)_{8{}2,6-(CH₃)₂PhO}₄(PhCH₂NH)₄ (λmax 807 nm), VOPc(2,5-Cl₂PhO)₈(2,6-Br₂-4-CH₃PhO)₄{Ph(CH₃)CHNH}₃F (λmax 835 nm), VOPc(2,5-Cl₂PhO)₈(2,6-Br₂-4-CH₃PhO)₄{PhCH₂NH}₃F(λmax 840 nm), VOPc(2,5-Cl₂PhO)₈(2,6-(CH₃)₂PhO)₄{Ph(CH₃)CHNH}₃F (λmax 828 nm), VOPc(2,6-Cl₂PhO)₈(2,6-(CH₃)₂PhO)₄{Ph(CH₃)CHNH}₃F (λmax 835 nm), VOPc(4-CNPhO)₈(2,6-Br₂-4-CH₃PhO)₄{Ph(CH₃)CHNH}₃F (λmax 836 nm), and VOPc(4-CNPhO)₈(2,6-(CH₃)₂PhO)₄{Ph(CH₃)CHNH}₃F (λmax 834 nm). Those having maximum absorption wavelength at 850 to 920 nm include, VOPc(2,5-Cl₂PhO)_{8{}2,6-(CH₃)₂PhO}₄(PhCH₂NH)₄(λmax 870 nm), VOPc(PhS)₈{2,6-(CH₃)₂PhO)₄(PhCH₂NH)₄ (λmax 916 nm), and VOPc(2,5-Cl₂PhO)₄(2,6-(CH₃)₂PhO)₄{(C₂H₅)₂NCH₂CH₂NH}₄ (λmax 893 nm), are included.

As specific examples of such (I), EX Color IR-10A, EX Color IR-12, EX Color IR-14, and TX-EX-906B (all produced from Nippon Shokubai Co., Ltd.) are included.

The abovementioned (I) may be used alone or in combination of two kinds of phthalocyanine-based compounds and/or naphthalocyanine-based compounds as phthalocyanine (I).

(II) having maximum absorption wavelength at 920 to 1100 nm, which is more preferably used in the present invention, is a phthalocyanine-based compound represented by the following formula (5):

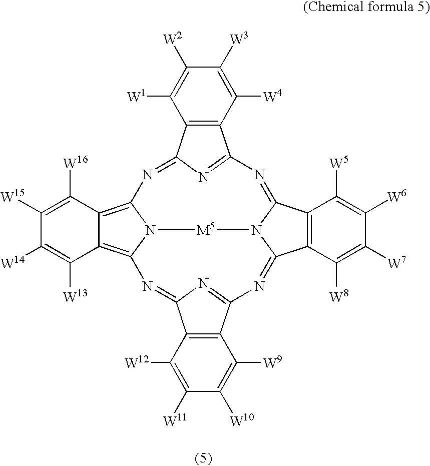

In the formula (5), W¹ to W¹⁶ represent functional groups, and each independently represent a halogen atom, an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, a heterocyclic group which may be substituted, and having carbon atoms of 2 to 20, and an amino group which may be substituted. Functional groups, W¹ to W¹⁶, may be any of the same kind or different kind, and also in the case of the same kinds, they may be the same or different, and functional groups themselves may be bonded via a linking group. More preferably, at least 4 groups among functional groups W¹ to W¹⁶ in formula (5), each independently, are those such as an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, and an aralkylthio group which may be substituted, and having carbon atoms of 7 to 20, and al least 4 groups, each independently, are a heterocyclic group which may be substituted, and having carbon atoms of 2 to 20 and an amino group which may be substituted. These substituents may be the same kind or different kind, also in the case of the same kinds, and the functional groups themselves may be bonded via a linking group.

M⁵ represents 2 hydrogen atoms, a bivalent metal atom, a trivalent or tetravalent substituted metal atom or an oxy metal. In the case when M⁵ represents a bivalent metal atom, a trivalent or tetravalent substituted metal atom or an oxy metal, examples described in the formula (1) are included.

As substituents present, if necessary, to alkoxy group, aryloxy group, aralkyloxy group, alkylthio group, arylthio group, aralkylthio group, and heterocyclic group in formula (5), for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like are included, however, they are not limited thereto. These substituents may be present in plural, and when they are present in plural, they may be any of the same kind or different kind, and also in the case of the same kinds, they may be the same or different. Substituents themselves may be bonded via a linking group.

As substituents to an amino group which may be substituted in formula (5), hydrogen atom; straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, and naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; aralkylcarbonyl groups such as benzylcarbonyl group; and the like are included, however, they are not limited thereto, and these substituents to an amino group may further be substituted by a substituent. These substituents to an amino group may not be present, or one or two may be present. When they are present in two, they may be any of the same kind or different kind each other, and also in the case of the same kinds, they may be the same or different. When two substituents are present, they themselves may be bonded via a linking group.

As substituents which may further be present to alkyl group, aryl group, aralkyl group, alkylcarbonyl group, arylcarbonyl group, aralkylcarbonyl group, and the like, which are substituents to the amino group which may be substituted, for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, they may be any of the same kind or different kind, and also in the case of the same kinds, they may be the same or different. In addition, substituents themselves may be bonded via a linking group.

Further, (II) having maximum absorption wavelength at 920 to 1100 nm, which is more preferably used in the present invention, is a naphthalocyanine-based compound represented by the following formula (6):

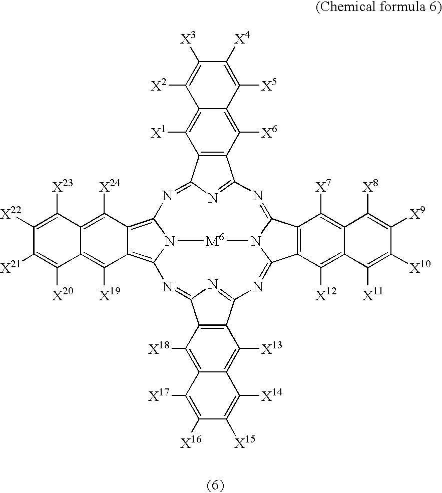

In the formula (6), X¹ to X²⁴ represent functional groups, and each independently represent a halogen atom, an alkoxy group which may be substituted, and having carbon atoms of 1 to 20, an aryloxy group which may be substituted, and having carbon atoms of 6 to 20, an aralkyloxy group which may be substituted, and having carbon atoms of 7 to 20, an alkylthio group which may be substituted, and having carbon atoms of 1 to 20, an arylthio group which may be substituted, and having carbon atoms of 6 to 20, an aralkylthio group which may be substituted, and having carbon atoms of 7 to 20, a heterocyclic group which may be substituted, and having carbon atoms of 2 to 20, and an amino group which may be substituted. Functional groups X¹ to X²⁴ may be any of the same kind or different kind, and also in the case of the same kinds, they may be the same or different, and functional groups themselves may be bonded via a linking group. M⁶ represents 2 hydrogen atoms, a bivalent metal atom, a trivalent or tetravalent substituted metal atom or an oxy metal. In the case when M⁶ represents a metal, examples described in the formula (1) are included.

As substituents present, if necessary, to alkoxy group, aryloxy group, aralkyloxy group, alkylthio group, arylthio group, aralkylthio group, and heterocyclic group in formula (6), for example, halogen atom, acyl group, alkyl group, phenyl group, alkoxy group, halogenated alkyl group, halogenated alkoxy group, nitro group, amino group, alkylamino group, alkylcarbonylamino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, heterocyclic group, and the like are included, however, they are not limited thereto. These substituents may be present in plural, and when they are present in plural, they may be any of the same kind or different kind, and also in the case of the same kinds, they may be the same or different. Substituents themselves may be bonded via a linking group.

As substituents to an amino group which may be substituted in formula (6), hydrogen atom; straight, branched, or cyclic alkyl groups such as methyl group, ethyl group, n-propyl group, n-butyl group, sec-butyl group, n-pentyl group, n-hexyl group, 2-ethylhexyl group, and cyclohexyl group; aryl groups such as phenyl group, and naphthyl group; aralkyl groups such as benzyl group, and phenethyl group; straight, branched, or cyclic alkylcarbonyl groups such as acetyl group, ethylcarbonyl group, n-propylcarbonyl group, iso-propylcarbonyl group, n-butylcarbonyl group, iso-butylcarbonyl group, sec-butylcarbonyl group, t-butylcarbonyl group, n-pentylcarbonyl group, n-hexylcarbonyl group, cyclohexylcarbonyl group, n-heptylcarbonyl group, 3-heptylcarbonyl group, and n-octylcarbonyl group; arylcarbonyl groups such as benzoyl group, and naphthylcarbonyl group; and aralkylcarbonyl groups such as benzylcarbonyl group; are included, however, they are not limited thereto, and these substituents to an amino group may further be substituted by a substituent. These substituents to an amino group may not be present, or one or two may be present. When they are present in two, they may be any of the same kind or different kind each other, and also in the case of the same kinds, they may be the same or different. When two substituents are present, they themselves may be bonded via a linking group.

As substituents which may further be present to alkyl group, aryl group, aralkyl group, alkylcarbonyl group, arylcarbonyl group, aralkylcarbonyl group, and the like, which are substituents to the amino group which may be substituted, for example, halogen atom, acyl group, alkyl group, phenyl group, alkoxy group, halogenated alkyl group, halogenated alkoxy group, nitro group, amino group, alkylamino group, alkylcarbonyl amino group, arylamino group, arylcarbonylamino group, carbonyl group, alkoxycarbonyl group, alkylaminocarbonyl group, alkoxysulfonyl group, alkylthio group, carbamoyl group, aryloxycarbonyl group, cyano group, and heterocyclic group are included, however, they are not limited thereto. These substituents may be present in plural, and when they are present in plural, they may be any of the same kind or different kind, and also in the case of the same kinds, they may be the same or different. In addition, substituents themselves may be bonded via a linking group.

In the present invention, use in combination of one or more kinds having maximum absorption wavelength at over 920 nm and smaller than 950 nm and one or more kinds having maximum absorption wavelength at 950 to 1100 nm, as the (II), provides advantages of high transmittance of visible light of a NIR absorption filter, and enabling to efficiently cut NIR light.

Among the (II), those having maximum absorption wavelength at over 920 nm and smaller than 1100 nm are exemplified below. In the abbreviation of the following compounds, Ph represents a phenyl group, Pc represents a phthalocyanine nucleus, and just before Pc, M⁵ are shown, and just after Pc, 8 substituents at β-positions of a phthalocyanine nucleus (substitution positions of W², W³, W⁶, W⁷, W¹⁰, W¹¹, W¹⁴ and W¹⁵) are shown, and after the substituents at the β-positions, 8 substituents at α-positions of a phthalocyanine nucleus (substitution positions of W¹, W⁴, W⁵, W⁸, W⁹, W¹², W¹³ and W¹⁶) are shown.

Those having maximum absorption wavelength at over 920 nm and smaller than 950 nm include as follows: VOPc(PhS)_{8{}2,6-(CH₃)₂PhO}₄{(C₂H₅)₂NCH₂CH₂NH}₄ (λmax 941 nm), VOPc(PhS)_{8{}2,6-(CH₃)₂PhO}₄[{CH₃(CH₂)₂CH}₂NCH₂CH₂NH]₄ (λmax 944 nm),

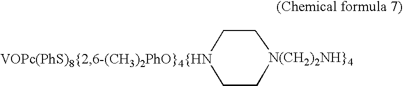

(λmax 923 nm),

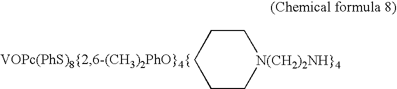

(λmax 922 nm), VOPc(PhS)_{8{}2,6-(CH₃)₂PhO}₄{(CH₃CH₂—O—(CH₂)₃NH)₄) (λmax 928 nm), VOPc(PhS)_{8{}2,6-(CH₃)₂PhO}₄{(CH₃)₂CHO(CH₂)₃NH)}₄(λmax 930 nm), VOPc(PhS)_{8{}2,6-(CH₃)₂PhO}₄{CH₃(CH₂)₃—O—(CH₂)₃NH}₄ (λmax 930 nm), VOPc(PhS)_{8{}2,6-(CH₃)₂PhO}₄{CH₃(CH₂)₃CH(C₂H₅)CH₂—O—(CH₂)₃NH}₄ (λmax 933 nm), VOPc(PhS)_{8{}2,6-(CH₃)₂PhO}₄{CH₃(CH₂)₅NH}₄ (λmax 930 nm), VOPc(PhS)_{8{}2,6-(CH₃)₂PhO}₄{CH₃(CH₂)₃CH(C₂H₅)CH₂NH}₄(λmax 939 nm), VOPc(PhS)_{8{}2,6-(CH₃)₂PhO}₄{CH₃(CH₂)₇NH}₄ (λmax 931 nm), VOPc(PhS)_{8{}2,6(CH₃)₂PhO}₄{CH₃(CH₂)₁₇NH}₄) (λmax 935 nm).

Those having maximum absorption wavelength at 950 to 1100 nm include as follows: VOPc{4-(CH₃O)PhS}_{8{}2,6-(CH₃)₂PhO}₄{CH₃(CH₂)₃CH(C₂H₅)CH₂NH}₄ (λmax 968 nm), VOPc{2-(CH₃O)PhS}_{8{}2,6-(CH₃)₂PhO}₄{(C₂H₅)₂NCH₂CH₂NH}₄) (λmax 950 nm), VOPc(PhS)_{8{}2,6-(CH₃)₂PhO}₄[{(CH₃)₂CH)₂NCH₂CH₂NH]₄ (λ max 952 nm), VOPc(2,5-Cl₂PhO)₈(PhCH₂NH)₈(λmax 1020 nm).

As specific examples of such (II), TX-EX-910B and TX-EX-902K (all produced from Nippon Shokubai Co., Ltd.) are preferably included.

The above mentioned (II) may be used alone or in combination of two kinds of phthalocyanine-based compounds and/or naphthalocyanine-based compounds as phthalocyanine (II).

The method for producing (I) and (II) according to this invention does not need to be particularly restricted but may be properly selected from among the known methods such as described in JP-A-2004-309655.

As (II) having maximum absorption wavelength at a region of over 920 nm, which can be used in a NIR absorption filter of the present invention, those enabling to exhibit a visible light transmittance of not lower than 65%, preferably not lower than 70% in measurement of a transmittance spectrum, in a solution wherein concentration of the phthalocyanine is adjusted so that minimum value of the transmittance in a NIR region of over 920 nm, more preferably 920 to 1100 nm is 5 to 6%, are included.

Compounding amount of the (I) and (II) to a pressure-sensitive adhesive resin is not especially limited as long as it is such amount as enabling to attain desired property, in particular, efficient cutting ability of NIR, excellent transparency in visible light region, heat resistance and hygrothermal resistance. Preferably, Compounding amount of the (I) and (II) is 0.1 to 10 parts by weight, more preferably 0.5 to 8 parts by weight and most preferably 1 to 5 parts by weight based on 100 parts by weight of solid content of a pressure-sensitive adhesive resin, in the case when dry film thickness is set to 10 to 30 μm. In this case, the compounding amount of the (I) and (II) below 0.1 parts by weight is insufficient in compounding of phthalocyanine, and unable to obtain excellent shielding ability of NIR, while the compounding amount even over 10 parts by weight does not provide improvement of the performance comparable to the addition of phthalocyanine, and therefore not economical, and has risk to lose transparency in visible region. In this connection, the compounding amount of the (I) and (II) may be changed depending on setting of transmittance in visible and NIR regions of an objective NIR absorption filter, and thickness of the NIR absorption filter. In addition, shape of the NIR absorption filter is not especially limited, and includes various shapes such as most general plate-like or film-like one, as well as corrugated plate-like, spherical-like and dome-like ones. As for the filter with profile such as a corrugated plate, weight in a projected area from upper side may be considered. Concentration unevenness of phthalocyanine is allowed as long as not posing an appearance problem.

In addition, compounding ratio of (I) to (II) is not especially limited as long it is as such ratio as enabling to fulfill desired NIR absorption ability and transparency, however, the ratio (weight ratio) of phthalocyanine (I) to (II) is preferably 2 to 8:8 to 2, more preferably 3 to 7:7 to 3 and most preferably 4 to 6:6 to 4.

### (2) A Pressure-Sensitive Adhesive Resin

A pressure-sensitive adhesive resin used in the present invention essentially has an acid value of not larger than 25. Forming a pressure-sensitive adhesive layer by compounding the (I) and (II) to such a resin enables to meaningfully suppress a reaction between an acid group of a pressure-sensitive adhesive resin and (II), and a pressure-sensitive adhesive layer formed exhibits excellent stability, which then enables to efficiently absorb NIR, provides excellent transparency in visible light region. Furthermore, forming a pressure-sensitive adhesive layer by combination with a pressure-sensitive adhesive resin enables to eliminate conventionally required separate formation of a NIR shield layer, which enables to meaningfully simplify a production step of a NIR absorption filter. Therefore, a pressure-sensitive composition using these is particularly suitably used in producing a front panel of plasma display or a NIR absorption filter for plasma display.

In the present invention, acid value of a pressure-sensitive adhesive resin is not larger than 25. Reason for this limitation is that acid value within this range provides high stability in a pressure-sensitive adhesive resin, of (II) used as a NIR absorption agent, which is contained in the pressure sensitive adhesive resin, which in turn enables to fulfill function of excellent NIR absorption or transparency more stably. Acid value of a pressure-sensitive adhesive resin is preferably 0 to 20, more preferably 0 to 10 and most preferably 0. “Acid value” in the present description represents quantity of potassium hydroxide, in mg, required to neutralize 1 g of a sample.

In addition, a pressure-sensitive adhesive resin used in the present invention preferably has a hydroxyl value of not higher than 10, more preferably, a hydroxyl value of a pressure-sensitive resin is 0 to 10, further more preferably 0 to 5 and most preferably 0 to 2.

As material used in the present embodiments and having the above property, specifically, (meth)acrylic resin, polyester-based resin, urethane-based resin, epoxy-based resin, polyurethane ester-based resin, or fluorine-based resins such as polytetrafluoroethylene (PTFE), perfluoroalkoxy resin (PFA) composed of tetrafluoroethylene and perfluoroalkyl vinyl ether copolymer, tetrafluoroethylene and hexafluoropropylene copolymer (FEP), tetrafluoroethylene and perfluoroalkyl vinyl ether and hexafluoropropylene copolymer (EPE), tetrafluoroethylene and ethylene or propylene copolymer (ETFE), polychlorotrifluoroethylene resin (PCTFE), ethylene and chlorotrifluoroethylene copolymer (ECTFE), vinylidene fluoride resin (PVDF), vinyl fluoride resin (PVF); polyimide-based resins such as polyimide, polyamideimide, polyetherimide; silicone-based resin, and the like are included. Among these, a (meth)acrylic resin is preferable.

A (meth)acrylic resin particularly preferably used in the present invention represents a (meth)acrylic polymer having an acid value of not higher than 25, which is polymerized using a (meth)acrylate ester as a monomer and used as raw material of a pressure-sensitive adhesive. In this case, a (meth)acrylic resin essentially has an acid value of not larger than 25, therefore not to use a (meth)acrylic acid as a monomer is particularly preferable. A (meth)acrylic polymer may be obtained by polymerization using only one kind of a (meth)acrylate ester, or two or more kinds of (meth)acrylate esters as a monomer(s), or using a (meth)acrylate ester, and a compound copolymerizable with a (meth)acrylate ester (hereinafter described as “a copolymerizable compound”), as monomers. In this connection, “a (meth)acrylic resin” represents both a polymer not crosslinked by a crosslinking agent, and a polymer crosslinked by a crosslinking agent, however, preferably has structure crosslinked at least apart.

In the present invention, as specific examples of a (meth)acrylate ester used as a monomer, alkyl(meth)acrylates having carbon atoms of 1 to 20, such as methyl(meth)acrylate, ethyl(meth)acrylate, propyl(meth)acrylate, butyl (meth)acrylate, pentyl(meth)acrylate, hexyl(meth)acrylate, octyl(meth)acrylate, nonyl(meth)acrylate, decyl (meth)acrylate, dodecyl(meth)acrylate, 2-ethylhexyl (meth)acrylate, and substitution products thereof; (meth)acrylates having a hydroxyl group, such as 2-hydroxyethyl(meth)acrylate, 2-hydroxybutyl (meth)acrylate, 2-hydroxypropyl(meth)acrylate, and 2-hydroxy-3-phenoxypropyl(meth)acrylate; aryl (meth)acrylates such as phenyl(meth)acrylate, benzyl (meth)acrylate; alkoxyalkyl(meth)acrylates such as methoxyethyl(meth)acrylate, ethoxyethyl(meth)acrylate, butoxyethyl(meth)acrylate, and ethoxypropyl (meth)acrylate; alcohol oxyalkylene adducts of (meth)acrylate such as ethoxydiethyleneglycol (meth)acrylates, phenoxydiethyleneglycol (meth)acrylates, phenoxypolyethyleneglycol (meth)acrylates, nonylphenol ethylene oxide (EO) adducts of (meth)acrylate, nonylphenol propylene oxide (PO) adducts of (meth)acrylate; cycloalkyl (meth)acrylate such as cyclohexyl(meth)acrylate; and the like are included. However, a (meth)acrylate ester other than these compounds may be used. The (meth)acrylate ester may be used singly or as in a mixed form of two or more kinds.

As a copolymerizable compound used as a monomer, if necessary, for example, a compound having an ethylenic unsaturated bond is included. Here, “a compound having an ethylenic unsaturated bond” represents a compound wherein a hydrogen atom in ethylene (CH₂═CH₂) is substituted. Other compound may be used as a monomer as long as enabling copolymerization with a (meth)acrylate ester, and not inhibiting the effect of the present invention. As other examples of a copolymerizable compound, aromatic vinyl monomers such as styrene, vinyltoluene, α-methylstyrene, vinylnaphthalene, and halogenated styrene; vinylester monomers such as vinyl acetate; halogenated vinyl monomers such as vinyl chloride, and vinylidene chloride; amide group containing vinyl monomers such as (meth)acrylamide, N-methylol (meth)acrylamide, N-methoxymethyl (meth)acrylamide, N-butoxymethyl(meth)acrylamide, and N,N-dimethyl acrylamide; nitrile group containing monomers such as acrylonitrile; and vinyl ether-based monomers; are included. In addition, in the present invention, a monomer containing a carboxyl group, such as a (meth)acrylic acid may be used as a copolymerizable compound, within a range that acid value of a pressure-sensitive adhesive resin to be produced is not over 25.

As a monomer preferably used in the present invention, among the above monomers, 2-ethylhexyl(meth)acrylate, butyl (meth)acrylate, cyclohexyl(meth)acrylate, and 2-hydroxyethyl(meth)acrylate are preferably included. In the present invention, polymerization using at least a monomer having high glass transition temperature (Tg) (hereinafter referred to as “a high Tg monomer”) among theses monomers to produce a (meth)acrylic resin according to the present invention, is preferable. Reason for such production is that the resultant a pressure-sensitive adhesive layer by polymerization using such a high Tg monomer has excellent adhesive properties and improved heat resistance. In this case, Tg of a high Tg monomer preferably is 50 to 150° C. and most preferably 60 to 100° C. In this connection, a high Tg monomer preferably is an alicyclic monomer, because use of an alicyclic monomer enables to attain improvement of weatherability, or heat resistance due to increase in thermal degradation temperature, compared with a conventional (meth)acrylic resin. An example of an alicyclic monomer which can be used here is not especially limited, and includes (meth)acrylic alicyclic monomers, particularly, cyclohexyl (meth)acrylate, cyclopentyl(meth)acrylate, isobornyl (meth)acrylate, and the like.

In the present invention, a (meth)acrylic resin is synthesized by polymerization/copolymerization of monomers, and a method for polymerization of a (meth)acrylic resin is not especially limited, and well-known methods can be used. A method for polymerization may suitably be selected depending on a monomer to be used or work environment, among solution polymerization, suspension polymerization, emulsion polymerization, bulk polymerization, and the like. Preferably, solution polymerization is used. Reason for adoption of solution polymerization is that polymerization heat during polymerization is easily removed, and workability of a polymerization reaction is excellent.

As a solvent used in the case of solution polymerization, aromatic hydrocarbons such as toluene, and xylene; aliphatic esters such as ethyl acetate, and butyl acetate; alicyclic hydrocarbons such as cyclohexane; aliphatic hydrocarbons such as hexane and pentane; and the like are included. However, other compounds may be used as long as not to inhibit a polymerization reaction, and thus a solvent is not especially limited to these. The above solvent may be used singly or as in a mixed form of two or more kinds. Use amount of a solvent is not especially limited, and may be determined, as appropriate, depending on kind or amount of a monomer.

Furthermore, a polymerization initiator used in polymerization reaction is also not especially limited. As a polymerization initiator, well-known radical polymerization initiators such as organic peroxide such as methyl ethyl ketone peroxide, benzoyl peroxide, dicumyl peroxide, t-butyl hydroperoxide, cumene hydroperoxide, t-butyl peroxyoctoate, t-butyl peroxybenzoate, lauroyl peroxide, tradename “NYPERBMT-K40” (produced from NOF Corp.; mixture of m-toluoyl peroxide and benzoyl peroxide); azo compounds such as azobisisobutyronitrile, trade name “ABN-E” [produced from Japan Hydrazine Inc.; 2,2′-azobis(2-methylbutyronitrile)]; can be used. Two or more kinds of polymerization initiators may be used in combination, in some cases.

Use amount of a polymerization initiator is preferably 0.01 to 1% by weight based on total weight of monomers. Excess use amount of a polymerization initiator may not yield a high molecular weight (meth)acrylic resin excellent in tackiness.

Polymerization conditions such as polymerization temperature or polymerization time may be set, as appropriate, depending on kind of a monomer, kind of a polymerization solvent, kind of a polymerization initiator, characteristics required to the resultant (meth)acrylic resin, applications of pressure-sensitive adhesive, and the like. Polymerization pressure is also not especially limited, and any of normal pressure, reduced pressure or under pressurized condition may be adopted. In this connection, a polymerization reaction is desirably carried out under inert gas atmosphere such as nitrogen gas.

Composition of the resultant (meth)acrylic resin as above is not especially limited. Total weight of a repeating unit derived from a (meth)acrylare ester contained in a (meth)acrylic resin is preferably 70 to 99.9% by weight. Total weight of a repeating unit derived from a (meth)acrylate ester within this range expresses sufficient adhesive characteristics.

To yield a (meth)acrylic resin having sufficient tackiness, weight average molecular weight of a (meth)acrylic resin to be used is preferably not lower than 200,000, and more preferably not lower than 300,000. Upper limit of weight average molecular weight of a (meth)acrylic resin to be used is not especially limited. In view of difficulty in synthesis, weight average molecular weight of a (meth)acrylic resin to be used is preferably not higher than 2,000,000, and more preferably not higher than 1,000,000.

In the present invention, crosslinking of a pressure-sensitive adhesive resin, in particular, a (meth)acrylic resin, using a crosslinking agent is preferable to exhibit sufficient function as a pressure-sensitive adhesive. However, at the stage of an pressure-sensitive adhesive composition, a (meth)acrylic resin may not be crosslinked by a crosslinking agent, or in an already crosslinked form by a crosslinking agent. Therefore, a pressure-sensitive adhesive composition of the present invention may contain or may not contain a crosslinking agent. When a pressure-sensitive adhesive is produced using a pressure-sensitive adhesive composition of the present invention not containing a crosslinking agent, a pressure-sensitive adhesive is formulated in the composition and is molded in a form responsive to objective, and subsequently a (meth)acrylic resin may be crosslinked.

As a crosslinking agent to be used here, polyfunctional isocyanate compounds such as tolylene diisocyanate, xylylene diisocyante, tetramethylene diisocyanate, hexamethylene diisocyante, trimethylhexamethylene diisocyante, tolidine diisocyante, 4,4′-diphenylmethane diisocyante, isophorone diisocyante, 1,5-naphthalene diisocyanate, dicyclohexylmethane-4,4-diisocyanate, trans-vinylene diisocyanate, triphenylmethane diisocyanate, and polyphenylmethane diisocyanate; block isocyanate compounds protected with a blocking agent, such as polyhydric alcohol-based, phenol-based, acid amide-based, acid imide-based, ketone oxime-based, aldehyde oxime, lactone-based, and lactam-based; polyvalent metal complexes such as ethyl acetoacetate aluminum diisopropylate, aluminum tris(ethyl acetoacetate), aluminum monoacetyl acetonate bis(ethyl acetoacetate), aluminum tris(acetyl acetonate), titanium acetylacetonate, ammonium titanium lactate, and zirconium ammonium carbonate; epoxy-based compounds such as polyglycidyl ether-based, polyglycidyl amine-based, polyglycidyl ester-based, hydantoin-based, triglycidyl isocyanurate-based, and bisphenol-based; melamine compounds such as polymethylol melamine, and alkylated methylol melamine; and the like are included. However, compounds other than exemplified can also be used as a crosslinking agent. In addition, the crosslinking agent may be used singly or as in a mixed form of two or more kinds.

In the present invention, when a pressure-sensitive adhesive composition contains a crosslinking agent, use amount thereof is preferably 0 to 4 parts by weight, more preferably 0 to 2.5 parts by weight based on 100 parts by weight of a pressure-sensitive adhesive resin (preferably a (meth)acrylic resin). The use amount of the crosslinking agent out of this range may not fulfill sufficient adhesive properties.

In addition, as other preferable pressure-sensitive adhesive resin which can be used in the present invention, a polymer having first polymer moieties with a glass transition temperature of not lower than 50° C., and second polymer moieties with a glass transition temperature lower than 0° C. in the same molecule, (hereinafter referred to as the polymer (A)), is included. A polymer, such as the polymer (A), having two or more polymer moieties with different glass transition temperature, is generally well-known to take micro-phase separated structure, wherein polymer moieties having high glass transition temperature form discontinuous phase (micro-domain) and takes pseudo-crosslinked structure, which provides high cohesive strength even if crosslinking is not carried out by a crosslinking agent, and the like. Meanwhile, polymer moieties having low glass transition temperature form continuous phase and expresses tackiness. Therefore, use of the polymer (A) as a pressure-sensitive adhesive resin is preferable due to maintaining excellent tackiness, as well as having high cohesive strength even if a crosslinking agent is not used, and further improving heat resistance and hygrothermal resistance of a pressure-sensitive adhesive composition.

As the polymer (A), any one may be adopted as long as it has structure comprising the first polymer moieties with a glass transition temperature of not lower than 50° C., and the second polymer moieties with a glass transition temperature lower than 0° C., in the same molecule. As such a polymer, for example, a block copolymer or a graft copolymer is included.

As an example of a method for producing the block copolymer or the graft copolymer, the following methods are included: A method for ionic polymerization using an organometal compound as an initiator (3M Co., Ltd., JP-A-60-8379), a method for radical polymerization using an iniferter (Otsu, Osaka City University, “Living mono- and biradical polymerization in homogeneous synthesis of an AB and ABA type block copolymers”, Polymer Bulletin, 11, 135-142 (1984)), a method for radical polymerization using a polyvalent mercaptan (JP No. 2842782, JP No. 3385177, and the like), a method for radical polymerization using a macromonomer (JP-A-2-167380), and the like. Among these, a method for radical polymerization using a polyvalent mercaptan is preferable, because a block copolymer can be synthesized in low cost.

As a polymerizable monomer which can be used in the polymer (A), any monomer can be used as long as it forms a homopolymer or a copolymer by radical polymerization.

A specific example of such a monomer, for example, (meth)acrylates represented by alkyl(meth)acrylate having carbon atoms of 1 to 30, hydroxyethyl(meth)acrylate, hydroxypropyl(meth)acrylate, glycidyl(meth)acrylate, methoxyethyl(meth)acrylate, ethoxyethyl(meth)acrylate, and ethoxyethoxyethyl(meth)acrylate; styrene-based monomers represented by α-methylstyrene, vinyltoluene, and styrene; maleimide-based monomers represented by phenylmaleimide, and cyclohexylmaleimide; vinyl ether-based monomers represented by methyl vinyl ether, ethyl vinyl ether, isobutyl vinyl ether; fumaric acid, and monoalkyl fumarate, dialkyl fumarate; maleic acid, monoalkyl maleate, and dialkyl maleate; itaconic acid, monoalkyl itaconate, and dialkyl itaconate; (meth)acrylonitrile, butadiene, isoprene, vinyl chloride, vinylidene chloride, vinyl acetate, vinyl ketone, vinylpyridine, vinylcarbazole; and the like are included. They may be used singly or as in a mixed form of two or more kinds.

In addition, as the first polymer moieties with a glass transition temperature of not lower than 50° C. in a first stage, use of a macromonomer is also possible. As the macromonomer, any polymer can be used as long as it has a glass transition temperature of not lower than 50° C., and a polymerizable double bond at one terminal. As an example of such macromonomer, polymethyl methacrylate (AA-6, produced from Toagosei Co., Ltd.), polystyrene (AS-6, produced from Toagosei Co., Ltd), poly(acrylonitrile-styrene) (AN-6, produced from Toagosei Co., Ltd), and the like are included.

Monomers used in a polymer moieties with a glass transition temperature of not lower than 50° C., and polymer moieties with a glass transition temperature lower than 0° C., are not especially limited as long as glass transition temperature thereof calculated by the Fox equation represented by the following equation satisfies a specified value.

1/(Tg+273)=Σ[Wi/(Tgi+273)]: Fox equation

Tg (° C.): Glass transition temperature

Wi: Weight fraction of each monomer

Tgi (° C.): Glass transition temperature of a homopolymer of each monomer component

The first polymer moieties with a glass transition temperature of not lower than 50° C. is designed in view of action to enhance cohesion strength of the polymer (A), and preferably has as higher glass transition temperature as possible, preferably not lower than 60° C., more preferably not lower than 70° C. and further preferably not lower than 80° C.

The second polymer moieties with a glass transition temperature of lower than 0° C. is designed in view of action to furnish tackiness of the polymer (A), and preferably has as lower glass transition temperature as possible, preferably Tower than 10° C., more preferably lower than −20° C. and further preferably lower than −30° C.

Weight ratio (weight ratio of solid content) of the first polymer moieties to the second polymer moiety is 3/97 to 50/50. The weight ratio of the first polymer moieties below 3% by weight may not provide effect to improve cohesive strength, while the weight ration over 50% by weight may provide insufficient tackiness.

In this connection, when the polymer (A) is used in a resin composition of the present invention, an optical filter for plasma display desirably has high transmittance at 400 nm to 800 nm, namely visible light range.

The polymer (A) has micro-phase separated structure, which tends to provide lower transmittance compared with usual random copolymers. However, optimization of composition, weight ratio and further a synthesis method for the high Tg polymer moieties and the low Tg polymer moieties enables to improve transmittance. The average transmittance at 400 nm to 800 nm is preferably not lower than 50%, more preferably not lower than 60% and further preferably not lower than 70%.

One of preferable methods for producing the polymer (A) is explained below. The polymer (A) is obtained by a multi-stage polymerization step in the presence of polyvalent mercaptan, and preferably by carrying out the multi-stage polymerization step using monomer components with different composition each other, at least in the first stage and the second stage of a polymerization step in the multi-stage polymerization step.

Namely, to be a star-shaped block copolymer obtained by carrying out multi-stage radical polymerization, in the presence of polyvalent mercaptan, using different kinds of polymerizable monomers in each stage is one of the preferably production embodiments.

As for production procedure, by radical polymerization of the first polymerizable monomer component forming polymer moieties with a glass transition temperature of not lower than 50° C., as the first stage, in the presence of polyvalent mercaptan, and subsequently after polymerization conversion reaches to not lower than 50%, preferably not lower than 60%, by the addition of the second polymerizable monomer component forming polymer moieties with a glass transition temperature of lower than 0° C., to polymerize as the second stage, a polymer having the first polymer moieties with a glass transition temperature of not lower than 50° C., and the second polymer moieties with a glass transition temperature lower than 0° C. in the same molecule can be obtained. Reason for setting polymerization conversion in the radical polymerization carried out first to not lower than 50% is to make property of a polymer forming the second polymer moiety different as far as possible, even if the subsequent polymerization is carried out without removing a polmerizable monomer which remains after polymerization. Therefore, removal by volatilization of a polmerizable monomer after the first polymerization is also possible.

When radical polymerization is carried out by the addition of the second polmerizable monomer component, sequentially after stopping radical polymerization of the first polymerizable monomer at a polymerization conversion of 70% as the first stage, this second stage generates a copolymer composed of 30% monomers unreacted in the first stage polymerization, and the monomer added as the second polymer component.

As the polyvalent mercaptan, diesters formed by a diol and a mercaptan having a carboxyl group, such as ethyleneglycol dithioglycolate, ethyleneglycol dithiopropionate, 1,4-butanediol dithioglycolate, and 1,4-butanediol dithiopropionate; triesters formed by a triol and a mercaptan having carboxyl group, such as trimethylolpropane trithioglycolate, and trimethylolpropane trithiopropionate; polyesters formed by a compound having four hydroxyl groups and a mercaptan having a carboxyl group, such as pentaerythritol tetrakisthioglycolate, and pentaerythritol tetrakisthiopropionate; polyesters formed by a compound having six hydroxyl groups and a mercaptan having a carboxyl group, such as dipentaerythritol hexakisthioglycolate, and dipentaerythritol hexakisthiopropionate; polyester compounds formed by a compound having three or more hydroxyl groups and a mercaptan having a carboxyl group; compounds having three or more mercapto groups, such as trithioglycerin; polythiols of triazine, such as 2-di-n-butylamino-4,6-dimercapto-s-triazine, and 2,4,6-trimercapto-s-triazine; compounds introduced with multiple mercapto groups formed by the addition of hydrogen sulfide to multiple epoxy groups in polyepoxy compounds; ester compounds formed by esterification of multiple carboxyl groups in polycarboxylic acids and mercaptoethanol; are include. Any one of them may be used singly or as in a mixed form of two or more kinds. “Mercaptans having carboxyl group” here include compounds having one mercapto group and one carboxyl group, such as thioglycolic acid, mercaptopropionic acid, thiosalicylic acid, and the like.

A method for polymerization of a star-shaped block copolymer is not especially limited, and well-known methods are used. A method for polymerization of a star-shaped block copolymer may suitably be selected depending on a monomer to be used or work environment, among solution polymerization, suspension polymerization, emulsion polymerization, bulk polymerization, and the like. Preferably, solution polymerization is used.

As a solvent used in solution polymerization, aromatic hydrocarbons such as toluene, and xylene; aliphatic esters such as ethyl acetate, and butyl acetate; alicyclic hydrocarbons such as cyclohexane; aliphatic hydrocarbons such as hexane, and pentane; and the like are include.

Furthermore, a polymerization initiator used in a polymerization reaction is also not especially limited, and well-known polymerization initiators such as organic peroxide such as methyl ethyl ketone peroxide, benzoyl peroxide, dicumyl peroxide, t-butyl hydroperoxide, cumene hydroperoxide, t-butyl peroxyoctoate, t-butyl peroxybenzoate, lauroyl peroxide, trade name “NYPER BMT-K40” (produced from NOF Corp.; mixture of m-toluoyl peroxide and benzoyl peroxide); azo compounds such as azobisisobutyronitrile, trade name “ABN-E” [produced from Japan Hydrazine Inc., 2,2′-azobis(2-methylbutyronitrile)] may be used. In some cases, two kinds or more polymerization initiators may be used in combination.

Use amount of a polymerization initiator is preferably not more than ⅓, more preferably not more than ⅕ in weight ratio, based on polyvalent mercaptan. Higher use amount than this ratio generates a large quantity of polymers extended from the polymerization initiator, other than polymer moieties extended from polyvalent mercaptan giving a block copolymer, which lowers formation efficiency of a block copolymer, and also lowers cohesive strength of the resultant polymer.

Polymerization conditions such as polymerization temperature or polymerization time may be set, as appropriate, depending on kind of a monomer, kind of a polymerization solvent, kind of a polymerization initiator, characteristics required to a star-shaped block polymer, applications of pressure-sensitive adhesive, and the like. Polymerization pressure is also not especially limited, and any of normal pressure, reduced pressure or under pressurized condition may be adopted.

A pressure-sensitive adhesive resin according to the present invention may be used as it is, however, preferably dissolved in an organic solvent, and a solvent which can be used here is not especially limited as long as it enables to dissolve a pressure-sensitive adhesive resin, and a well-known organic solvent can be used. Specifically, hydrocarbon solvents such as toluene, xylene, hexane, and ethyl acetate are included. Other solvents can also be used not especially limited thereto, as long as not impairing a polymerization reaction. Among these, ethyl acetate and toluene are preferable. In this case, these solvents may be used singly or as in a mixed form of two or more kinds. In addition, solid content concentration of the pressure-sensitive adhesive resin is also not especially limited, however, preferably 10 to 80%, and more preferably 20 to 60%. In this case, the solid content concentration below 20% may not be economical due to longer time required for drying, while over 60% may impair coating property caused by too high viscosity.

In a pressure-sensitive adhesive composition of the present invention, a tackifier may be contained. “A tackifier” in the present invention represents an additive to enhance adhesive strength by being blended with a resin.

As a tackifier, various well-known tackifiers such as a rosin-based resin, a terpene-based resin, a petroleum-based resin, a coumarone-based resin, a xylene-based resin and a styrene-based resin can be used. These tackifiers may be used singly or as in a mixed form of two or more kinds. Among these tackifiers, a generally cheap rosin-based resin, terpene-based resin, or a petroleum-based resin are preferably used. In addition these resins exhibit intense coloring in many cases, and significance of compounding of a fluorescent whitening agent is high. However, tackifiers to be used are not limited thereto, and other tackifiers may be used.

A rosin-based resin is gum rosin collected from a pine tree, wood rosin obtained by extraction with a petroleum solvent after chipping a pine tree stump, rosin such as tall oil rosin obtained from a cooking waste solution in producing craft pulp, and derivatives thereof. Rosin is composed of several isomers represented by the general formula, C₁₉H₂₉COOH, and small amount of neutral components, and the composition differs depending on kind of raw wood, production area and a purification step of rosin. The main component is usually abietic acid. Rosin derivatives represent rosin subjected to modification such as hydrogenation, disproportionation or dimerization, to improve stability to oxidation. As rosin derivatives, hydrogenated rosin, disproportionated rosin, polymerized rosin, and the like are included. Rosin derivatives are synthesized based on rosin, and commercial products such as trade name “Hypale” (produced from Arakawa Chemical Industries, Ltd.), and trade name “Polypale” (produced from Hercules A.G.) may also be used.

A terpene-based resin is a resin using turpentine oil, as raw material obtained in producing rosin from a pine tree. Turpentine oil includes gum turpentine oil, wood turpentine oil, sulphate turpentine oil, and the like. The composition depends on kind of raw wood, production area and a purification step of a terpene-based resin. The main component of a terpene-based resin is usually α-pinene. As other components, β-pinene, camphene, dipentene, and the like may be contained. As a specific example of a terpene-based resin, terpene, terpene phenol, rosin phenol, terpene modified by aromatic compound, hydrogenated terpene, and the like are included. In addition to these, various well-known terpene-based resins can be used. A terpene-based resin may be synthesized, or commercial rosin derivatives such as trade name “Tamanol 803” (produced from Arakawa Chemical Industries, Ltd.) and trade name “zonatac” (produced from Arizona Chemical Co., Ltd.) may also be used.

A petroleum-based resin is one obtained by cationic polymerization of distillates containing unsaturated hydrocarbon byproducts by thermal decomposition of petroleum naphtha, and the like. A petroleum-based resin is classified largely by kinds of component monomers or molecular structure, into an aliphatic type petroleum-based resin, an aromatic type petroleum-based resin, a copolymer type petroleum-based resin, and the like. An aliphatic type petroleum-based resin is a resin obtained by cationic polymerization of distillates having a boiling point of 20 to 80° C. in naphtha decomposition oil, using aluminum chloride as a catalyst. An aromatic type petroleum-based resin is one obtained by cationic polymerization of C₉ distillates containing styrenes or indenes in naphtha decomposition oil, using aluminum chloride or a BF₃ catalyst. A copolymer type petroleum-based resin is a resin obtained by cationic polymerization of a mixture of C₅ distillates and C₉ distillates in suitable ratio.

Amount of a tackifier contained in a pressure-sensitive composition of the present invention is preferably 5 to 100 parts by weight, more preferably 10 to 50 parts by weight based on 100 parts by weight of a pressure-sensitive adhesive resin. Too low content of a tackifier may provide insufficient improvement effect of adhesive strength by a tackifier. On the contrary, too high content of a tackifier may reduce tackiness and lower adhesive strength.

Into a pressure-sensitive adhesive composition of the present invention, conventionally well-known additives such as a filler, a pigment, a thinner, an antioxidant, a UVA (an ultraviolet ray absorption agent), a HALS (a hindered amine light stabilizer), and a UV ray stabilizer may be added, if necessary. Among these, when a composition of the present invention is used in panel applications such as PDP, a UVA (an ultraviolet ray absorption agent) and a HALS (a hindered amine light stabilizer) are preferably used. A UVA (an ultraviolet ray absorption agent) is not especially limited and a well-known ultraviolet ray absorption agent can be used. In addition, a HALS (a hindered amine light stabilizer) is also not especially limited and a well-known hindered amine light stabilizer can be used. The addition amount of theses additives may be set, as appropriate, so that desired property is obtained. For example, the addition amount of a UVA is 0.1 to 100% by weight, more preferably 2 to 20% by weight based on total weight of a pressure-sensitive adhesive composition. In addition, for example, the addition amount of a HALS is 0.1 to 50% by weight, and more preferably 0.5 to 10% by weight based on total weight of a pressure-sensitive adhesive composition.

A pressure-sensitive adhesive composition of the present invention contains (I) and (II), and a specified pressure-sensitive adhesive resin, as essential components, as described above, and thanks to such a composition, decrease in NIR shielding performance or transparency is not observed even when a pressure-sensitive adhesive layer and a NIR shield layer is formed as a single layer, and also the resultant a pressure-sensitive adhesive layer enables to fulfill various properties such as excellent heat stability (heat resistance), hygrothermal resistance or light resistance. Therefore, a pressure-sensitive adhesive composition of the present invention can suitably be used in producing a NIR absorption material, an optical filter or plasma display (in particular, a front panel of plasma display or a NIR absorption filter for plasma display). In this connection, a pressure-sensitive adhesive composition of the present invention can be used, other than the above applications, as a film or sheet for optical, agriculture, construction, vehicles and image recording applications; a showcase for a freezer and a refrigerator; a solar cell such as die-sensitizing type solar cell; photosensitive material using semiconductor laser light as light source; information recording medium such as for optical disk; asthenopia prevention material; photothermal conversion material such as photosensitive paper, and adhesives or pressure sensitive adhesive substance, in particular, a film or sheet for optical and image recording applications; information recording medium such as for optical disk; photothermal conversion material such as photosensitive paper; and adhesives or pressure sensitive adhesive substance.

### (3) A NIR Absorption Material

A NIR absorption material of the present invention is one obtained by lamination of a layer containing the pressure-sensitive adhesive composition on a transparent substrate.

The transparent substrate is not especially limited as long as it is usable as general optical substance and is substantially transparent. As a specific example, glass; olefin-based polymers such as cyclopolyolefin, and amorphous polyolefin; methacrylic-based polymers such as polymethyl methacrylate; vinyl-based polymers such as polyvinyl acetate, and polyvinyl halide; polyesters such as PET; polycarbonate; polyvinyl acetal such as butyral resin; polyaryl ether-based resins; and the like are included. Furthermore, the transparent substrate may be subjected to surface treatment by a conventionally well-known method such as corona discharge treatment, flame treatment, plasma treatment, glow discharge treatment, surface roughening treatment, and chemical treatment, or coating with an anchor coating agent or a primer. In addition, the substrate resin can be formulated with well-known additives, a heat resistant antioxidant, a lubricant and an antistatic agent, and can be formed into a film or sheet-shape using a well-known method such as injection molding, T-die molding, calender molding and compression molding, or a casting method by solving in an organic solvent. A substrate composing such a transparent substrate may be non-oriented or oriented, or laminated with other substrate.

As a transparent substrate in the case when a NIR absorption material is used as a film, glass, a PET film, an easy adhesion type PET film, an antireflection film or an electromagnetic wave shield film are preferable, and a PET film is more preferable, and a PET film, in particular, a treated one for easy adhesion, is particularly suitable. Specifically, Cosmoshine A4300 (produced from Toyobo Co., Ltd.), Lumiler U34 (produced from Toray Industries, Inc.), Melinex 705 (produced from Teijin Dupont Films Japan, Ltd.), and the like are included.

In addition, by using an antireflection film, an antiglare film, an impact absorption film, an electromagnetic wave shield film and the like, as a transparent substrate, an optical filter for plasma display can simply be produced. Use of a film is preferable.

Thickness of a NIR absorption material of the present invention is generally about 10 μm to 10 mm, however, it is determined, as appropriate, depending on objective. In addition, content of a NIR absorption dye contained in a NIR absorption material is also determined, as appropriate, depending on objective.

A method for forming a pressure-sensitive adhesive layer using a pressure-sensitive adhesive composition of the present invention, on a transparent substrate, is not especially limited and a well-known coater can be used. For example, a knife coater such as a comma coater, a slot die coater, a fountain coater such as a lip coater, a kiss coater such as a micro gravure coater, a gravure coater, a roll coater such as a reverse roll coater, a flow coater, a spray coater, a bar coater, and the like can be used. Surface treatment before application by a well-known method such as corona discharge treatment and plasma treatment may be carried out. As drying and curing methods, a well-known method using hot air, far infrared ray, UV curing, and the like can be used. After drying and curing, a film may be winded with a well-known protection film. In addition, such a method may also be used as application on a release film by these methods, and the like, and subsequently laminating it on a transparent substrate. As a release substrate, paper or film coated with a silicone-based, an olefin-based, an oil-based, a fluorine-based release agent, a fluorine-based substrate, an olefin-based substrate, and like can be used. In addition, as a transparent substrate or an applicator, the above ones can be used.

In addition, thickness of a pressure-sensitive adhesive layer in the above method is not especially limited, and can be determined, as appropriate, depending on desired applications (for example, applications for a front panel of plasma display or a NIR absorption filter for plasma display), however, preferably 5 to 50 μm, and more preferably 10 to 30 μm.

The resultant a pressure-sensitive adhesive layer by such methods can firmly be adhered to other parts such as other substrate or plasma display panel by a well-known method, and can fulfill excellent NIR absorption ability and transparency, as well as is excellent in various properties such as heat stability (heat resistance), hygrothermal resistance or light resistance.

A NIR absorption material of the present invention can be component material of an optical filter for plasma display excellent in durability and NIR absorption ability. A NIR absorption material of the present invention has high stability, and therefore maintains appearance and NIR absorption ability even in storage or use for a long period.

Furthermore, due to having such features, it can be used as a filter or film requiring cutting of infrared ray, for example, a heat insulation film, sunglasses, optical recording material, without limiting to display applications.

### (4) An Optical Filter for Plasma Display

An optical filter for plasma display of the present invention is a filter which uses the NIR absorption material.

Such an optical filter has a total light transmittance in visible ray region of not lower than 40%, preferably not lower than 50%, further preferably not lower than 60%, and a transmittance of NIR at a wavelength of 800 to 1200 nm, of not higher than 30%, preferably not higher than 15%, further preferably not higher than 5%.

An optical filter of the present invention may be attached with a supporting substance such as an electromagnetic wave shield layer, an antireflection layer, an antiglare layer, a scratch prevention layer, a color adjusting layer, an impact absorption layer and glass, other than a NIR absorption layer composed of the NIR absorption material.

An optical filter having a NIR absorption layer and an antireflection layer is obtained by laminating a layer composed of a pressure-sensitive adhesive composition of the present invention, at the back surface of the antireflection layer, or by application of an antireflection coating agent on a NIR absorption material of the present invention.

An antireflection layer is one to suppress reflection at a surface and to prevent intrusion of exterior light such as a fluorescent light onto a surface. An antireflection layer may be composed of a thin film of an inorganic substance such as a metal oxide, a fluoride, a silicide, a boride, a carbide, a nitride and a sulfide, or may be composed of one obtained by lamination of resins with different refractive index such as an acrylic resin and a fluorocarbon resin, in a single layer or a multiple layer. In the former case, such a method is adopted as forming using a vapor deposition method or a sputtering method, in a single layer or a multiple layer form on a transparent substrate. In addition, in the latter case, a method for antireflection coating is adopted using a knife coater such as a comma coater, a slot coater, a fountain coater such as a lip coater, a gravure coater, a flow coater, a spray coater; or a bar coater, at the surface of a transparent substrate.

In addition, an optical filter having a NIR absorption layer and an antiglare layer is obtained either by laminating a layer composed of a pressure-sensitive adhesive composition of the present invention at the back surface of the antiglare layer, or by application of an antiglare coating agent on a NIR absorption material of the present invention.

An antiglare layer is formed by preparing ink from fine powder of silica, a melamine resin, an acrylic resin, and the like, and application thereof on any of layers of a filter of the present invention, by a conventional application method, and subsequently subjecting to thermal curing or photo-curing. In addition, a film after antiglare treatment may be pasted on the filter. An scratch prevention layer is formed by application of a coating solution dissolved or dispersed with an acrylate such as urethane acrylate, epoxy acrylate, and a multifunctional acrylate, and a photopolymerization initiator into an organic solvent, on any of layers of an optical filter of the present invention, preferably at the position of the most exterior layer, using a conventional application method, followed by drying and photo-curing.

An optical filter having a NIR absorption layer and an electromagnetic wave shield layer can be obtained by laminating a layer composed of the NIR absorption composition on the electromagnetic wave shield layer.

As for the electromagnetic wave shield layer, a film obtained by patterning a metal mesh thereon by a method for etching or printing, and the like, and then flattening thereof with a resin, or a film obtained by vapor deposition of a metal on a fiber mesh, and embedded thereof in a resin, can be used. As a resin to flatten a metal mesh on a film, a pressure-sensitive adhesive composition can also be used. In addition, as a resin to embed a fiber deposited with a metal, a NIR absorbing composition of the present invention can also be used.

An impact absorption layer is one to protect display equipment from exterior impact, and preferably used in an optical filter without having a supporting substance. As an impact absorption layer, an ethylene-vinyl acetate copolymer, an acrylic polymer, polyvinyl chloride, urethane- or silicone-based resin, and the like, disclosed in JP-A-2004-246365 and JP-A-2004-264416 can be used, however, it is not limited thereto.

Composition of each layer of an optical filter may arbitrarily be selected. It is preferably a combination of at least two layers, namely any one layer of an antireflection layer and an antiglare layer, and a NIR absorption layer, or further preferably an optical filter having at least 3 layers in combination with an electromagnetic wave shield layer.

An antireflection layer or an antiglare layer should be the most exterior surface layer for a human side, and combination of a NIR absorption layer and an electromagnetic wave shield layer is arbitrary. In addition, other layers such as a scratch prevention layer, a color adjusting layer, an impact absorption layer, a supporting substance, and a transparent substrate may be inserted among 3 layers.

Each layer may be laminated with only a NIR absorption material of the present invention, or other pressure-sensitive adhesive or adhesives may be used in combination. Use of a NIR absorption material of the present invention enables to simplify composition of an optical filter for plasma display, and is therefore economical.

In laminating each layer, it may be subjected to physical treatment such as corona treatment and plasma treatment, or a well-known anchor coating agent of a polar polymer such as polyethyleneimine, an oxsazoline-based polymer, polyester, and cellulose may also be used.

### (5) A Plasma Display

A plasma display of the present invention is one wherein the optical filter for plasma display is used. The optical filter may be set apart from display equipment, or directly laminated on display equipment.

When it is directly laminated, use of an optical filter without a supporting substance is preferable, and use of an optical filter with an impact absorption layer is further preferable.

As material for pressure-sensitive adhesive in laminating to display equipment, rubber such as styrene butadiene rubber, polyisoprene rubber, polyisobutylene rubber, natural rubber, neoprene rubber, chloroprene rubber, butyl rubber; polyalkyl acrylate such as polymethyl acrylate, polyethyl acrylate, and polybutyl acrylate; and the like are included, and they may be used singly, however, those added with Piccolite, Polypale, rosin ester, and the like, as a tackifier, can also be used. In addition, pressure-sensitive adhesive having impact absorption ability such as disclosed in JP-A-2004-263084 can be used, however, not limited thereto.

Thickness of this pressure-sensitive adhesive layer is usually 5 to 2000 μm, and preferably 10 to 1000 μm. Setting a release film at the surface of a pressure-sensitive adhesive layer to protect the pressure-sensitive adhesive layer until it is laminated to the surface of plasma display, aiming at prevention of attachment of dust, and the like onto the pressure-sensitive adhesive layer is also preferable. In this case, forming a zone without setting a pressure-sensitive adhesive layer between a pressure-sensitive adhesive layer at the peripheral part of a filter and a release film, or forming a non-sticky zone by sandwiching a non-sticky film, and the like, aiming at providing a peel start part, makes laminating work easy.

### BRIEF DESCRIPTION OF THE DRAWINGS

FIG. 1 is a graph showing a visible-NIR absorption spectrum of the resultant test substance in Example 1.

FIG. 2 is a graph showing a visible-NIR absorption spectrum of the resultant test substance in Example 6.

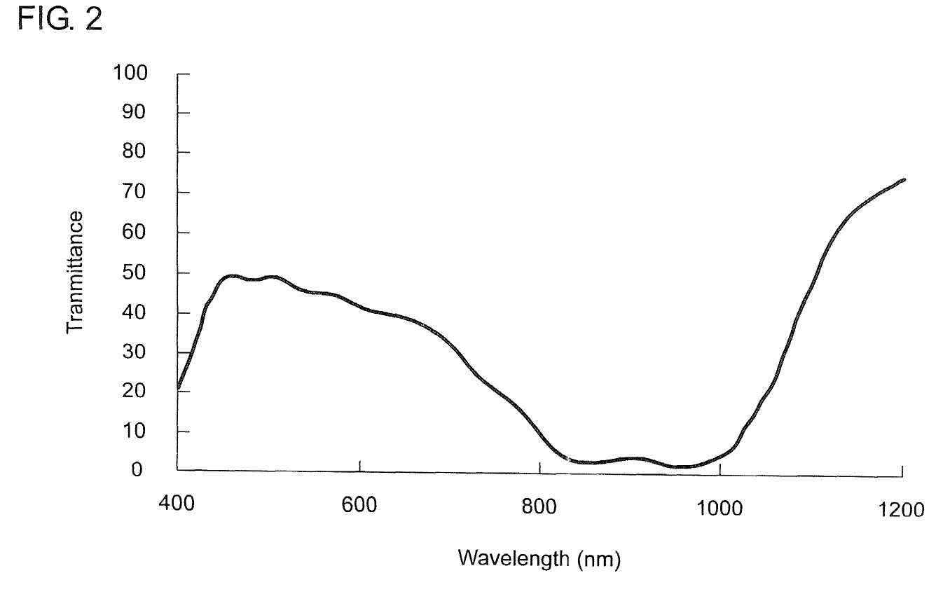

FIG. 3 is a graph showing a visible-NIR absorption spectrum of the resultant test substance in Example 7.

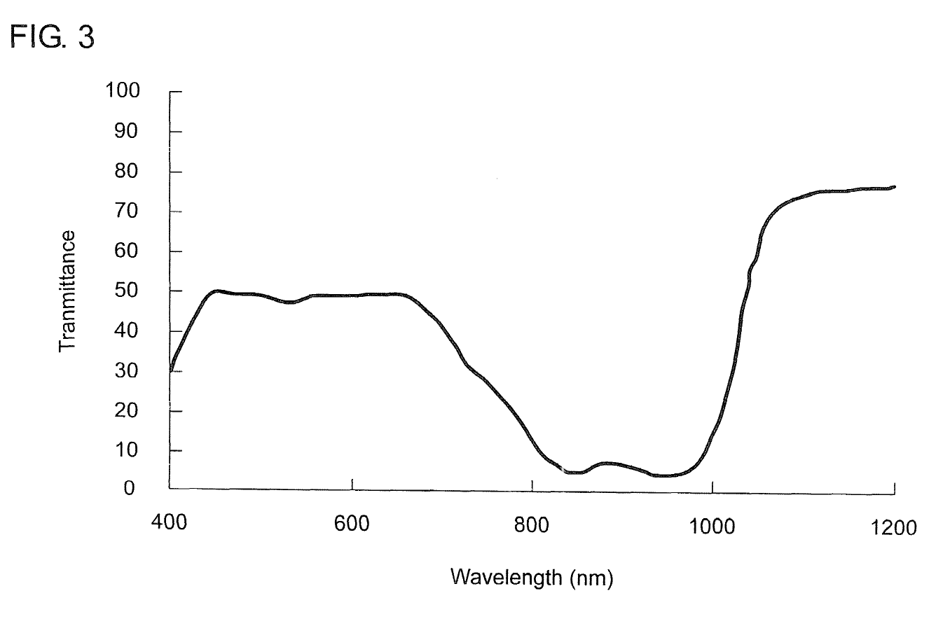

FIG. 4 is a graph showing a visible-NIR absorption spectrum of the resultant test substance in Example 10.

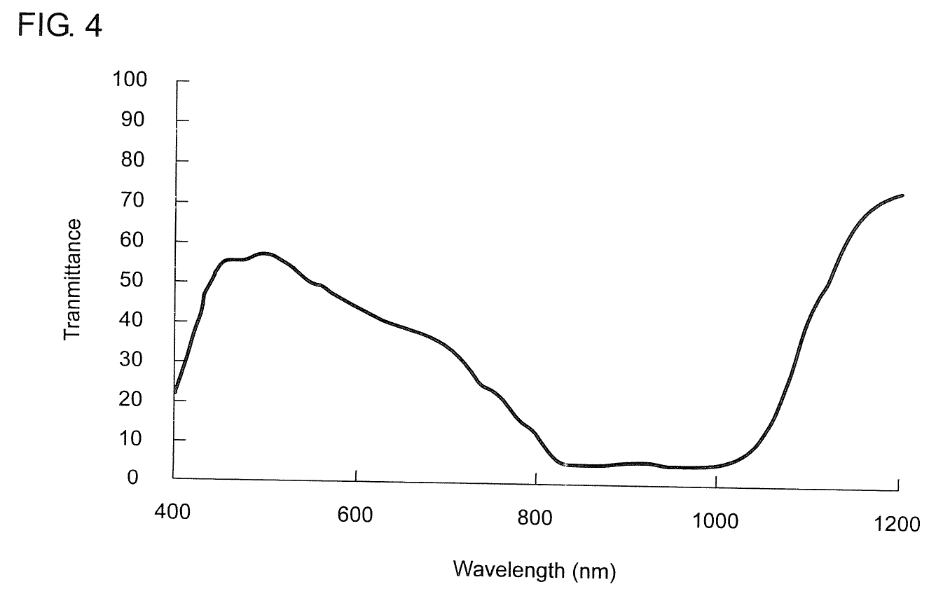

### EXAMPLES

The present invention is explained further more specifically by means of Examples, however, these Examples should by no means limit the present invention. In this connection, evaluation of NIR absorption ability, heat resistance, hygrothermal resistance, maximum absorption wavelength and adhesive properties (adhesive strength) was carried out in accordance with the following methods.

### 1. Evaluation of NIR Absorption Ability

Transmittance on each test piece was measured at 980 and 1050 nm as wavelength in a NIR region, using a spectrometer (UV-3700, produced from Shimadzu Corp.). In addition, transmittance was measured at 450 nm as transmittance in a visible ray region and each of the resultant transmittances is shown in the column, “before treatment”, in Table 2 below.

### 2. Evaluation of Heat Resistance

A test substance was stood still in an oven at 100° C. for 120 hours, and transmission spectra in a visible-infrared region were measured before and after the test. The change in the transmittance was measured using a spectrometer (UV-3700 produced from Shimadzu Corp.).

### 3. Evaluation of Hygrothermal Resistance

A test substance was stood still in a vessel held at a constant temperature and humidity of 80° C. and 90% R^{H} for 120 hours, and evaluated similarly as in the heat resistance test.

### 4. Measurement of Maximum Absorption Wavelength

Phthalocyanine or naphthalocyanine to be used was dissolved in specified amount of methyl ethyl ketone (MEK) and confirmed no presence of insoluble matter before absorbance measurement. For absorbance measurement, a spectrometer UV-1600 (produced from Shimadzu Corp.) was used, and a measurement cell made of glass with a light pass of 10 mm was used.

### 5. Evaluation of Adhesive Properties (Adhesive Strength)

Adhesive strength of the resultant pressure-sensitive film in the Examples and Comparative Examples below was measured in accordance with JIS-Z0237 as follows: An adhesive sheet with a width of 25 mm was laminated on a stainless steel plate (SUS304) by one reciprocation of a rubber roller of 2 kg weight in the atmosphere of 23° C. and 65% RH, and after 25 minutes, peeled in a 180 degree direction at a rate of 300 mm/min. Acceptance level (represented by “o” mark in Table 2) of adhesive strength is not lower than 100 g/25 mm.

In addition, acid value and hydroxyl value in Production Examples 1 to 4 and Comparative Production Example 1 are measured in accordance with the following method.

### 6. Measurement Method for Acid Value

Accurately weighed 0.5 g of an acrylic polymer solution was added with 50 g of toluene, and uniformly dissolved. An alcohol solution of phenolphthalein was added 2 to 3 drops as an indicator, for titration with a 0.1 N alcohol solution of potassium hydroxide, and time when reddish solution color disappeared in about 30 seconds was determined as an end point. Acid value was determined based on titration amount up to this point and resin solid content. Acid value represents amount of potassium hydroxide, in mg, required to neutralize 1 g of resin solid content.

### 7. Measurement Method for Hydroxyl Value

Hydroxyl value was measured in accordance with JIS K0070 by the following method.

### (Preparation of an Acetylation Agent)

An acetylation reagent was prepared by uniformly mixing pyridine/acetic anhydride=100/30 in volume ratio.

### (Preparation of an Aqueous Solution of Pyridine)

An aqueous pyridine solution was prepared by mixing pyridine (a first class reagent)/ion exchanged water=2/3 in volume ratio.

### (Preparation of a Methanol Solution of Koh)

About 70 g of KOH (a special grade reagent) was added with about 50 mL of ion-exchanged water and dissolved, to which methanol (a first grade reagent) was added to make about 1 L of a solution, and then dissolved by shaking. After standing still the solution not shorter than 1 night while shielding carbon dioxide, supernatant fluid thereof was taken up to titrate with a 1 mol/L hydrochloric acid solution with known factor, and determined factor (“f” in the equation below).

### (Titration)

Into an accurately weighed sample of 10 g, 5 mL of the acetylation agent was added using a whole pipette. The sample was completely dissolved and then immersed in an oil bath at 100±2° C. for 60 minutes. After the addition of 5 ml of the aqueous solution of pyridine using a whole pipette and homogeneous mixing, the solution was immersed in an oil bath at 100° C. for 10 minutes.

After subjecting the solution to cooling at room temperature, 40 mL of dioxane was added and mixed uniformly, and added 2 to 3 drops of a phenolphthalein indicator for titration with the methanol solution of potassium hydroxide. A time when the solution exhibited pale red color was determined as an end point to measure titration amount (“C” in the following equation).

Similarly, titration amount (“B” in the following equation) was also determined on a blank which was not added with a sample.

### (Calculation of Hydroxyl Value)

Hydroxyl value was calculated by the following equation.

Hydroxyl value represents amount of potassium hydroxide, in mg, equivalent to a hydroxyl group contained in 1 g of resin solid content.

Hydroxyl value={[(B−C)×f×56.1]/(s×N)}+A (Numerical Equation 1)

wherein B represents titration amount (mL) for a blank; C represents titration amount (mL) for a sample; s represents sample weight in g (10 g); f represents factor of the 1 mol/L methanol solution of KOH; A represents acid value of resin solid content; and N represents resin solid content.

### Production Example 1

### Preparation of an Acrylic Polymer Solution

As monomers, 2-ethylhexylacrylate (478.2 g), cyclohexyl methacrylate (120 g) and hydroxyethyl acrylate (1.8 g) were weighed and sufficiently mixed to yield a monomer mixture.

Into a flask equipped with a thermometer, a stirrer, an inert gas introducing tube, are flux condenser and a dropping funnel, were added 40% by weight of this monomer mixture and ethyl acetate (147 g). A monomer mixture for dropping composed of 60% by weight of the monomer mixture, ethyl acetate (16 g) and a polymerization initiator, NYPER BMT-K40 (0.72 g), was charged in the dropping funnel and sufficiently mixed.

While passing nitrogen gas in 20 mL/min, inner temperature of the flask was raised up to 84° C., and a polymerization initiator, NYPERBMT-K40 (0.96 g), was charged into the flask to initiate a polymerization reaction. After 10 minutes from charging the polymerization initiator, dropping of the monomer mixture for dropping, which had been charged in the dropping funnel, was started. The monomer mixture for dropping was uniformly dropped over 90 minutes. After completion of the dropping, ethyl acetate (50 g) was charged into the flask. Subsequently, the reaction solution was subjected to aging at 82° C. for 4.3 hours.

After completion of the reaction, ethyl acetate (44.4 g) was added, and finally the reaction solution was diluted with toluene so that nonvolatile matter was about 41% to yield an acrylic polymer (weight average molecular weight=41×0⁴) solution (1). The resultant acrylic polymer (1) had an acid value and a hydroxyl value of 0 and 1.4, respectively.

### Production Example 2

### Preparation of an Acryl-Based Polymer Solution

As monomers, 2-ethylhexyl acrylate (478.2 g), butyl acrylate (120 g), and hydroxyethyl acrylate (1.8 g) were weighed and sufficiently mixed to yield a monomer mixture.

Into a flask equipped with a thermometer, a stirrer, an inert gas introducing tube, a reflux condenser and a dropping funnel, were added 40% by weight of this monomer mixture and ethylacetate (147 g). A monomer mixture for dropping composed of 60% by weight of the monomer mixture, ethyl acetate (16 g) and a polymerization initiator, NYPER BMT-K40 (0.72 g), was charged in the dropping funnel and sufficiently mixed.

While passing nitrogen gas in 20 mL/min, inner temperature of the flask was raised the temperature up to 84° C., and a polymerization initiator, NYPER BMT-K40 (0.96 g), was charged into the flask to initiate a polymerization reaction. After 10 minutes from charging the polymerization initiator, dropping of the monomer mixture for dropping, which had been charged in the dropping funnel, was started. The monomer mixture for dropping was uniformly dropped over 90 minutes. After completion of the dropping, ethyl acetate (50 g) was charged into the flask. Subsequently, the reaction solution was subjected to aging at 82° C. for 4.3 hours.

After completion of the reaction, ethyl acetate (44.4 g) was added, and finally the reaction solution was diluted with toluene so that nonvolatile matter was about 41% to yield an acrylic polymer (weight average molecular weight=60×10⁴) solution (2). The resultant acrylic polymer (2) had an acid value and a hydroxyl value of 0 and 1.4, respectively.

### Production Example 3-a

### Production of Polymer Moieties Having a Glass Transition Temperature of not Lower than 50° C.

As monomers, methyl methacrylate (297 g) and NK-ester A-200 (produced from Shin-Nakamura Chemical Co., Ltd) (3 g), and ethyl acetate (300 g) as a solvent were added into a four necked 2 L flask equipped with a stirring apparatus, a nitrogen introducing tube, a dropping funnel, a thermometer, and a condenser, and raised the temperature up to 85° C. in nitrogen atmosphere. After the inner temperature reached 85° C., pentaerythritol tetrakisthiopropionate (9 g) as a polyvalent mercaptan, and azobisisobutyronitrile (0.45 g) as an initiator of radical polymerization, and ethyl acetate (9 g) as a solvent were charged to initiate polymerization. After 10 minutes from initiation of polymerization, methyl methacrylate (693 g), NK-ester A-200 (7 g), pentaerythritol tetrakisthiopropionate (21 g), azobisisobutyronitrile (1.05 g), ethyl acetate (31 g) were dropped over 110 minutes. After 170 minutes from initiation of polymerization, when polymerization conversion reached 70.2%, methoxyphenol (0.5 g) as a polymerization inhibitor, and ethyl acetate (475 g) as a solvent were added and cooled to complete the first stage of polymerization.

### Production Example 3

### Production of a Block Copolymer Using Polymer Moieties Having a Glass Transition Temperature of not Lower than 50° C.

The resultant first polymer moieties (1-a) (137.1 g) in Production Example 3-a, butyl acrylate (171.4 g) and ethyl acetate (124.2 g) were added into a four necked 2 L flask equipped with a stirring apparatus, a nitrogen introducing tube, a dropping funnel, a thermometer, and a condenser, and raised the temperature up to 85° C. in nitrogen atmosphere. After the inner temperature reached 85° C., azobisisobutyronitrile (0.14 g) and ethyl acetate (3.5 g) were charged to initiate polymerization. After 10 minutes from initiation of the reaction, the first polymer moieties (1-a) (205.7 g), butyl acrylate (257.1 g), azobisisobtutyronitrile (0.22 g), and ethyl acetate (192.4 g) were dropped over 110 minutes. After 60, 90, 120 and 150 minutes from completion of the dropping, azobisisobutyronitrile (0.15 g) and ethyl acetate (9 g) were charged at each point, further subjecting to a reaction for 4 hours under reflux, and then cooling to yield an acrylic polymer solution (3) with a solid content concentration of 50.6% and a weight average molecular weight of the polymer of 34×10⁴. The resultant acrylic polymer (3) had an acid value and a hydroxyl value of both 0.

### Production Example 4

By similar operation as in Production Example 3, polymerization was carried out using a composition shown in Table 1 to yield an acrylic polymer solution (4) with a solid content concentration of 50.3% and a weight average molecular weight of the polymer of 16×10⁴. The resultant acrylic polymer (4) had an acid value and a hydroxyl value of both 0.

### Production Example 5

### Production of a Graft Copolymer Using Macromonomer

Into a four necked 2 L flask equipped with a stirring apparatus, a nitrogen introducing tube, a dropping funnel, a thermometer, and a condenser, a macromonomer AA-6 (composed of a methacryloyl group as a polymerizable unsaturated group, methyl methacrylate as a monomer component, and having a calculated grass transition temperature of 105° C., produced from Tohagosei Co., Ltd.) (48 g), butyl acrylate (172.8 g), cyclohexyl methacrylate (19.2 g), ethyl acetate (179 g), toluene (179 g) were added, and raised the temperature up to 85° C. in nitrogen atmosphere. After the inner temperature reached 85° C., azobisisobutyronitrile (0.14 g) and ethyl acetate (3.5 g) were charged to initiate polymerization. After 10 minutes from initiation of polymerization, a macro monomer, AA-6 (72 g), butyl acrylate (259.2 g), cyclohexyl methacrylate (28.8 g), azobisisobutyronitrile (0.22 g),ethyl acetate (120 g), and toluene (120 g) were dropped over 110 minutes. After 60, 90, 120 and 150 minutes from completion of the dropping, azobisisobutyronitrile (0.15 g) and ethyl acetate (9 g) were charged at each point, further subjecting to a reaction for 4 hours under reflux, and then cooling to yield an acrylic polymer solution (5) with a solid content concentration of 49.2% and a weight average molecular weight of the polymer of 23×10⁴. The resultant acrylic polymer (5) had an acid value and a hydroxyl value of both 0.

### Example 1

By adding 2 parts by weight of a NIR absorption dye (VOPc{4-(CH₃O)PhS}_{8{}2,6-(CH₃)₂PhO}₄{CH₃(CH₂)₃CH(C₂H₅)CH₂NH}₄VOPc(PhS)_{8{}2,6-(CH₃)₂PhO}₄(PhCH₂NH)₄: VOPc(2,5-Cl₂PhO)₈(2,6-(CH₃)₂PhO)₄{Ph(CH₃)CHNH}₃F=5:2:5 in weight ratio, hereinafter being the same) per 100 parts by weight of solid content of an acrylic polymer solution (1) produced similarly as in a method described in the Production Example 1, and mixing and stirring until homogeneous state is obtained, a resin solution was prepared. Maximum absorption wavelengths (λmax) of (VOPc{4-(CH₃O) PhS}_{8{}2,6-(CH₃)₂PhO}₄{CH₃(CH₂)₃CH(C₂H₅)CH₂NH}₄ (hereinafter described as “Compound A”), VOPc(PhS)_{8{}2,6-(CH₃)₂PhO}₄(PhCH₂NH)₄ (hereinafter described as “Compound B”), VOPc (2,5-Cl₂PhO) 8 (2,6-(CH₃)₂PhO)₄{Ph (CH₃)CHNH}₃F (hereinafter described as “Compound C”) used in this Example were 968 nm, 916 nm and 828 nm (in MEK solvent), respectively.

The resin solution was coated on a release film by an applicator, so that thickness after drying is 25 μm, to form a pressure-sensitive adhesive layer. This layer was dried at 100° C. for 2 minutes. The pressure-sensitive adhesive layer was laminated with a PET film having a thickness of 25 μm (the pressure-sensitive adhesive layer was transcripted to this side). Adhesive properties of the pressure sensitive adhesive sample were evaluated and the result is shown in Table 2 below.

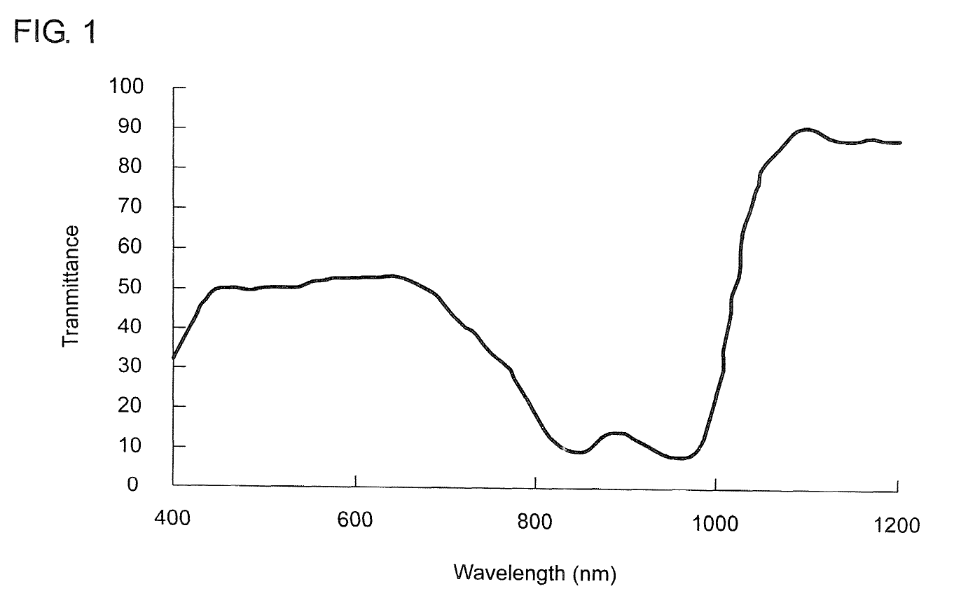

A resin solution produced similarly as the above was coated on a PET film (Cosmoshine A4300 produced from Tohyobo Co., Ltd.) treated for easy adhesion, using an applicator, and dried in a hot air drier at 100° C. for 2 minutes to yield a coating film with a thickness of 25 μm. On this film, a PET film treated for easy adhesion was laminated to yield a test substance. A visible-NIR absorption spectrum of the resultant test substance is shown in FIG. 1. In addition, a deterioration evaluation (evaluation of heat resistance and hygrothermal resistance) on this test substance was carried out and the result is shown in Table 2 below.

### Example 2

The same procedure as in Example 1 was carried out except that 2 parts by weight of a NIR absorption dye, phthalocyanine (Compound A: Compound C=5:5) were added per 100 parts by weight of solid content of the acrylic polymer solution (1) in Example 1. The result is shown in Table 2 below.

### Example 3

The same procedure as in Example 1 was carried out except that 2 parts by weight of a NIR absorption dye, phthalocyanine (Compound A: Compound B: Compound C=5:2:5) and 0.5 parts by weight of an isocyanate crosslinking agent, Coronate L-55E (trade name, produced from Japan Polyurethane Co., Ltd.) were added per 100 parts by weight of solid content of the acrylic polymer solution (1) in Example 1. The result is shown in Table 2 below.

### Example 4

The same procedure as in Example 1 was carried out except that the acrylic polymer solution (2) was used instead of the acrylic polymer solution (1) in Example 1. The result is shown in Table 2 below.

### Example 5

The same procedure as in Example 1 was carried out except that 2.7 parts by weight of a NIR absorption dye, phthalocyanine (VOPc(2,5-Cl₂PhO)₈ (PhCH₂NH)₈ (hereinafter described as “Compound D”: Compound A: Compound B: Compound C=4/5/2/5) was added per 100 parts by weight of solid content of the acrylic polymer solution (1) in Example 1. The result is shown in Table 2 below. Maximum absorption wavelengths (λmax) of phthalocyanine, Compound D used in this Example is 1020 nm (in MEK solvent). The result is shown in Table 2 below.

### Example 6

The same procedure as in Example 1 was carried out except that 2.5 parts by weight of a NIR absorption dye, phthalocyanine (Compound D: Compound B: Compound C=8/2/5) was added per 100 parts by weight of solid content of the acrylic polymer solution (1) in Example 1. The result is shown in Table 2 below.

### Example 7

The same procedure as in Example 1 was carried out except that the acrylic polymer solution (3) was used instead of the acrylic polymer solution (1) in Example 1. The result is shown in Table 2 below.

### Example 8

The same procedure as in Example 1 was carried out except that the acrylic polymer solution (4) was used instead of the acrylic polymer solution (1) in Example 1. The result is shown in Table 2 below

### Example 9

The same procedure as in Example 1 was carried out except that the acrylic polymer solution (5) was used instead of the acrylic polymer solution (1) in Example 1. The result is shown in Table 2 below

### Example 10

The same procedure as in Example 1 was carried out except that the acrylic polymer solution (3) was used instead of the acrylic polymer solution (1) in Example 6. The result is shown in Table 2 below.

### Comparative Example 1

The same procedure as in Example 1 was carried out except that 1 parts by weight of a diimmonium-based dye (a commercial item) and 1 parts by weight of a phthalocyanine-based dye (Compound C) was added per 100 parts by weight of solid content of the acrylic polymer solution (1) in Example 1. The result is shown in Table 2 below.

### Comparative Production Example 1

### Preparation of an Acrylic Polymer Solution

As monomers, 2-ethylhexyl acrylate (126 g), butyl acrylate (422 g), acrylic acid (96.6 g), vinyl acetate (30 g) and hydroxyethyl acrylate (0.6 g) were weighed and sufficiently mixed to yield a monomer mixture.

Into a flask equipped with a thermometer, a stirrer, an inert gas introducing tube, a reflux condenser and a dropping funnel, were added 40% by weight of this monomer mixture and ethylacetate (339 g). A monomer mixture for dropping composed of 60% by weight of the monomer mixture, ethyl acetate (38.5 g) and a polymerization initiator, ABN-E (0.09 g), was charged in the dropping funnel and sufficiently mixed.

While passing nitrogen gas in 20 mL/min, inner temperature of the flask was raised up to 82° C., and a polymerization initiator, ABN-E (0.09 g), was charged into the flask to initiate a polymerization reaction. After 15 minutes from charging the polymerization initiator, dropping of the monomer mixture for dropping, which had been charged in the dropping funnel, was started. The monomer mixture for dropping was uniformly dropped over 90 minutes. After completion of the dropping, ethyl acetate (70 g) was charged into the flask. Subsequently, the reaction solution was subjected to aging at 80° C. for 5.5 hours.

After completion of the reaction, ethyl acetate (650 g) was added, and finally the reaction solution was diluted with ethyl acetate so that nonvolatile matter was about 30% to yield a comparative acrylic polymer solution (6). The resultant comparative acrylic polymer (6) had an acid value and a hydroxyl value of 27.2 and 0.5, respectively.

### Comparative Example 2

The addition of NIR absorption dye, and preparation of pressure-sensitive adhesive sample and evaluations of deterioration of a NIR absorption dye and adhesive properties were carried out similarly as in Example 1 except that the comparative acrylic polymer solution (6) was used instead of the acrylic polymer solution (1) in Example 1. The result is shown in Table 2 below.

TABLE 1

| Production Example | 3 | 4 | 5 |
|---|---|---|---|
| High Tg polymer moieties | 1-a | 1-a | AA-6 |

Second polyrizable monomer composition

| | | | |
|---|---|---|---|
| CHMA | | 35 | 10 |
| BA | 100 | | 90 |
| 2EHA | | 65 | |
| Solid content weight ratio | 20/80 | 10/90 | 15/85 |
| of High Tg polymermoieties/ | | | |
| Low Tg polymer moieties | | | |
| Calculated Tg of high Tg | 105 | 105 | 105 |
| polymer moieties | | | |
| Calculated Tg of low Tg | −45 | −30 | −46 |
| polymer moieties | | | |
| Mw | 34 × 10⁴ | 16 × 10⁴ | 23 × 10⁴ |
| Solid content | 50.6 | 50.3 | 49.2 |
| concentrarion (%) | | | |

CHMA: cyclohexyl methacrylate (Tg: 83° C.)
BA: butyl acrylate (Tg: −55° C.)
2EHA: 2-ethylhexyl acrylate (Tg: −70° C.)

TABLE 2

| | | Transmittance (%) at 450 nm | | | Transmittance (%) at 980 nm | | | Transmittance (%) at 1050 nm | | | |
|---|---|---|---|---|---|---|---|---|---|---|---|
| | | | | After | | | After | | | After | |
| | | | After heat | hygrothermal | | After heat | hygrothermal | | After heat | hygrothermal | |
| | Acrylic | Before the | resistance | resistance | Before the | resistance | resistance | Before the | resistance | resistance | adhesive |
| | polymer | treatment | test | test | treatment | test | test | treatment | test | test | strength |
| Exp. 1 | 1 | 50.0 | 48.9 | 45.2 | 9.4 | 14.4 | 9.0 | 81.8 | 81.4 | 78.9 | ∘ |
| Exp. 2 | 1 | 50.3 | 50.5 | 44.4 | 7.0 | 11.6 | 6.7 | 79.2 | 79.4 | 77.3 | ∘ |
| Exp. 3 | 1 | 49.1 | 46.6 | 44.6 | 7.8 | 10.5 | 8.5 | 80.8 | 80.4 | 78.4 | ∘ |
| Exp. 4 | 2 | 51.2 | 50.1 | 45.0 | 8.5 | 15.3 | 11.4 | 82.1 | 81.3 | 81.8 | ∘ |
| Exp. 5 | 1 | 49.3 | 47.9 | 48.1 | 3.3 | 4.3 | 3.5 | 21.5 | 26.6 | 25.1 | ∘ |
| Exp. 6 | 1 | 52.2 | 49.8 | 51.5 | 4.2 | 6.4 | 5.3 | 11.5 | 17.1 | 13.5 | ∘ |
| Exp. 7 | 3 | 50.0 | 49.9 | 47.0 | 6.7 | 6.8 | 8.6 | 65.0 | 65.1 | 68.3 | ∘ |
| Exp. 8 | 4 | 52.4 | 53.0 | 52.2 | 6.9 | 6.1 | 6.8 | 66.3 | 67.7 | 67.2 | ∘ |
| Exp. 9 | 5 | 50.7 | 50.2 | 49.3 | 6.1 | 7.2 | 8.3 | 69.2 | 72.8 | 70.1 | ∘ |
| Exp. 10 | 3 | 53.6 | 53.8 | 52.4 | 5.1 | 6.1 | 5.4 | 13.1 | 15.5 | 13.8 | ∘ |
| Comp. | 1 | 60.0 | 55.1 | 53.5 | 9.6 | 54.6 | 60.6 | 12.3 | 54.4 | 61.9 | ∘ |
| Exp. 1 | | | | | | | | | | | |
| Comp. | 6 | 56.4 | 56.1 | 55.9 | 30.3 | 81.9 | 31.5 | 74.2 | 75.8 | 73.7 | ∘ |
| Exp. 2 | | | | | | | | | | | |

Exp. 1: Dye 2 parts, Compound A/Compound B/Compound C = 5/2/5
Exp. 2: Dye 2 parts, Compound A/Compound B/Compound C = 5/0/5
Exp. 3: Dye 2 parts, Compound A/Compound B/Compound C = 5/2/5, NCO addition
Exp. 4: Dye 2 parts, Compound A/Compound B/Compound C = 5/2/5, no alicyclic monomer
Exp. 5: Dye 2.7 parts, Compound D/Compound A/Compound B/Compound C = 4/5/2/5
Exp. 6: Dye 2.5 parts, Compound D/Compound A/Compound B/Compound C = 8/0/2/5
Exp. 7: Dye 2 parts, Compound A/Compound B/Compound C = 5/2/5
Exp. 8: Dye 2 parts, Compound A/Compound B/Compound C = 5/2/5
Exp. 9: Dye 2 parts, Compound A/Compound B/Compound C = 5/2/5
Exp. 10: Dye 2.5 parts, Compound D/Compound A/Compound B/Compound C = 8/0/2/5
Comp. Exp. 1: Dye 2 parts, DIM/Compound C = 1/1
Comp. Exp. 2: Dye 2 parts, Compound A/Compound B/Compound C = 5/2/5, polymer acid value: 27

From the above evaluation results, Examples 1 to 10 are shown to be pressure-sensitive adhesive compositions enabling to suppress transmittance in a NIR region while maintaining transmittance in a visible light region, and further having high performance in heat resistance and hygrothermal resistance.

In addition, Examples 5, 6 and 10, wherein Compound D having λmax of 1020 nm (in MEK solvent) was used, are shown to be excellent also in cutting efficiency of NIR light at 1050 nm.

On the contrary, in Comparative Example 1, a diimmonium-based dye deteriorated by heat treatment, and transmittance was increased in a NIR region. In addition, in Comparative Example 2, wherein an adhesive resin having an acid value of 27.2 was used, it is shown that transmittance significantly increases in a NIR region, and also heat resistance and hygrothermal resistance are inferior. This is considered to be brought about by the presence of an acid group in high quantity in a resin, which deteriorates the dye and in turn lowers cutting efficiency of NIR light, heat resistance and hygrothermal resistance of the dye.

The entire disclosure of Japanese Patent Application No. 2005-1357546 filed on 10 May, 2005 including specification, claims, drawings and summary are incorporated herein by reference in its entirety.

1. A pressure-sensitive adhesive composition, comprising: (I) at least one kind selected from phthalocyanine-based compound and naphthalocyanine-based compound having maximum absorption wavelength in a region from 800 to 920 nm, as near infrared ray absorption agents; (II) at least one kind selected from phthalocyanine-based compound and naphthalocyanine-based compound having maximum absorption wavelength in a region over 920 nm as near infrared ray absorption agents; and a pressure-sensitive adhesive resin having an acid value not higher than 25.

2. A pressure-sensitive adhesive composition according to claim 1, wherein said composition comprises at least one kind of compounds having maximum absorption wavelength at not smaller than 800 nm below 850 nm, and at least one kind of compounds having maximum absorption wavelength at 850 to 920 nm, as said (I).

3. A pressure-sensitive adhesive composition according to claim 1, wherein said composition comprises at least one kind of compounds having maximum absorption wavelength at over 920 nm and below 950 nm, and at least one kind of compounds having maximum absorption wavelength at 950 to 1100 nm, as said (II).

4. A pressure-sensitive adhesive composition according to claim 1, wherein said pressure-sensitive adhesive resin is a (meth)acrylic resin.

5. A pressure-sensitive adhesive composition according to claim 4, wherein said (meth)acrylic resin contains an alicyclic monomer as a monomer component.

6. A pressure-sensitive adhesive composition according to claim 1, wherein said pressure-sensitive adhesive resin is a polymer having first polymer moieties with a glass transition temperature of not lower than 50° C., and second polymer moieties having a glass transition temperature of below 0° C., in the same molecule.

7. A pressure-sensitive adhesive composition according to claim 1, wherein said pressure-sensitive adhesive resin is a block copolymer or a graft copolymer.

8. A pressure-sensitive adhesive composition according to claim 1, wherein said pressure-sensitive adhesive resin is a polymer comprising a polyvalent mercaptan moiety which is a residue moiety of mercapto groups in polyvalent mercaptan from where a proton is dissociated; the first polymer moieties extending radially from said polyvalent mercaptan moiety and having a glass transition temperature of not lower than 50° C.; and the second polymer moieties having a glass transition temperature of below 0° C., in the same molecule.

9. A pressure-sensitive adhesive composition according to claim 8, wherein said pressure-sensitive adhesive resin is one produced by multi-stage radical polymerization using different kinds of polymerizable monomers in each stage, in the presence of polyvalent mercaptan.

10. A pressure-sensitive adhesive composition according to claim 6, wherein said pressure-sensitive adhesive resin uses a macromonomer having a polymerizable double bond at one terminal, as a polymer moiety having a glass transition temperature of not lower than 50° C.

11. A near infrared ray absorption material which is made by lamination of a coating film containing pressure-sensitive adhesive composition according to claim 1, on a transparent substrate.

12. A near infrared ray absorption material according to claim 11, wherein said transparent substrate is selected from the group consisting of glass, a PET film, an easy adhesive PET film, an antireflection film and an electromagnetic wave shield film.

13. An optical filter for plasma display using a near infrared ray absorption material according to claim 11.

14. Plasma display using an optical filter according to claim 13.
